(19) United States
(12) Patent Application Publication
(10) Pub. No.: US 2006/0282835 A1
(43) Pub. Date: Dec. 14, 2006

(54) Systems and methods for managing tasks and reminders

(76) Inventor: Robert L. Bascom, Sauk City, WI (US)

Correspondence Address: LATHROP & CLARK LLP, 740 REGENT STREET SUITE 400, P.O. BOX 1507, MADISON, WI, 537011507, US

(21) Appl. No.: 11/139,856

(22) Filed: May 27, 2005

(51) Int. Cl. G06F 9/46

(52) U.S. Cl. 718/100

(57) ABSTRACT

A supervisor adds to a subordinate's tasks, verifies completion and/or awards incentives upon completion for tasks managed by a task management device. The subordinate can also add tasks and/or reminders. Each task/reminder can have various prompts to the subordinate, a completion time/window, a prompt frequency/interval, a task repetition frequency./interval, and/or a completion incentive. Upon someone approaching the task management device, sensors incorporated into the device activates and identifies active tasks based on data associated with the stored tasks. The subordinate is reminded of each active task, visually and/or audibly. The subordinate can indicate whether an active task has been completed. The supervisor reviews the tasks' status to verify whether a particular task has been completed, and, upon verification, awards an incentive associated with that task to the subordinate. An alarm clock or other device usable to display and/or record tasks and allow supervisor/subordinate interaction can include the task management device.

### BACKGROUND OF THE INVENTION

1. Field of the Invention

This invention is directed to systems for managing information.

2. Related Art

Various conventional systems and methods are known for aiding adults in managing personal information, such as task lists, appointments, reminders and the like. Such conventional systems and methods are commonly implemented using desktop software applications and/or portable devices such as personal digital assistants (PDA's). Most adults find such systems convenient and easy to use, because the tasks, to-do items, appointments, meetings and other events adults manage with such systems and methods are things that responsible adults either wish to do or feel an obligation to do.

Different types of systems and methods are used by parents to get their children to perform tasks and chores around the house. The major system used by parents is simply nagging their children until the task or chore is completed. Other commonly used systems include writing chores onto a calendar or using a desktop calendar application to manage such tasks and chores. However, such desktop software applications are designed with the assumption that the user actually wishes to perform the tasks and to do items that are entered onto the calendar. As most parents know, most children are able to readily ignore most reminders to do a task or chore, even when such reminders comprise the parent becoming angry with the child.

### SUMMARY OF THE DISCLOSED EMBODIMENTS

Conventional systems and methods for managing tasks and to do lists are designed with adults in mind, and thus assume that the user actually wishes to, or at least accepts the responsibility to, complete the task. In contrast, children, especially young children, find it quite easy to simply ignore the types of reminders used by conventional task management systems and methods. Likewise, parental nagging is often ignored by children until the parent loses his or her temper or threatens to punish the child unless the task or chore is completed. Task management systems and methods that are designed specifically with children in mind would be significantly more useful in aiding parents and their children to manage such tasks and chores.

This invention provides systems and methods for aiding children in managing their tasks and chores.

This invention separately provides systems and methods for repeatedly providing reminders to a user until the task is compete.

This invention separately provides systems and methods for providing incentives to users to aid them in completing tasks and chores.

This invention separately provides systems and methods for recording whether a user has completed a task or chore.

This invention separately provides systems and methods for allowing an incentive to be awarded to a user upon supervisor verification that the user has performed the task or chore.

This invention separately provides systems and methods for activating a reminder system based on indications that the user is present in the location of the reminder system.

This invention separately provides systems and methods for allowing a user or supervisor or to track completion of assigned tasks or chores.

This invention separately provides systems and methods for allowing a supervisor or user to track awards of incentives to the user for completion of assigned tasks or chores.

This invention separately provides systems and methods for allowing a supervisor to verify that a task or chore has been completed before awarding an incentive to the user.

Various systems and methods according to this invention provide a replacement for the constant reminding or nagging that supervisors typically use to remind their subordinates to perform tasks and to insure that the subordinates have in fact complete the tasks. In various exemplary embodiments, systems and methods according to this invention allow a supervisor, such as a parent, a guardian, a nanny, a babysitter, or other responsible person to add tasks to a list of tasks to be accomplished by a subordinate, verify that the subordinate has performed particular tasks on the list of tasks to be performed, and/or award incentives to the subordinate upon completing the tasks or chores. In various exemplary embodiments, the subordinate himself or herself can add task and/or reminders that are of concern to the subordinate.

In various exemplary embodiments, the tasks or reminders entered by the supervisor or subordinate can provide various types of prompts to the user, set a desired completion time or completion window for performing the task, set a desired frequency and/or interval for providing prompts reminding the user to perform the task, can set a desired frequency upon which the task is to be repeated, and/or can set a desired incentive to be awarded to the user upon completion of a particular task.

In various exemplary embodiments, when the user, such as a child or other person requiring supervision in order to ensure the person completes desired tasks and/or chores, approaches a device embodying various systems or methods according to this invention, various sensors incorporated in to the device sense this approach. In various exemplary embodiments, these senses can include motion sensors, light sensors and/or sound sensors. When the approach of the user is sensed, such as, for example, by the user entering a room and turning on a light or moving within the room, the device determines which previously entered tasks and/or chores are active. In various exemplary embodiments, an active chore is one that is either overdue or is to be announced to the user based on data associated with the task or chore.

In various exemplary embodiments, each such active task or chore is presented to the user to remind the user to perform the task or chore. In various exemplary embodiments, the task or chore can be presented by displaying a description of the task or chore to be performed on a display device, such as the display screen of a desktop computer or a personal digital assistant. Alternatively, in various exemplary embodiments, the task or chore can be presented to the user by playing a recorded verbal message from the supervisor describing, or reminding the user about, the task or chore. In various exemplary embodiments, the device can play and/or display each active task in turn to the user with a small pause between each task. In various other exemplary embodiments, the device can play and/or display a first active task to the user and then wait for the user to acknowledge the reminder. In various exemplary embodiments, the device can then allow the user to indicate whether the task has been completed or allow the user to skip to the next task.

In various exemplary embodiments, the device can be accessed by a supervisor to review the status of tasks being managed by the device. In various exemplary embodiments, the supervisor can review all of the tasks or various subsets of the tasks, such as completed tasks or incomplete tasks. In various exemplary embodiments, the supervisor can review tasks that the user has indicated are complete, allowing the supervisor to verify that the tasks have in fact been completed. In various exemplary embodiments, when the supervisor verifies that the tasks have been completed, various incentives associated with the completed tasks are then awarded to the user.

In various exemplary embodiments, the device in which the system and or method according to this invention has been implemented can be an alarm clock or other device having a display device usable to display tasks, record tasks, and allow the user and the supervisor to interact with the system and method according to this invention.

These and other features and advantages of various exemplary embodiments of systems and methods according to this invention are described in, or are apparent from, the following detailed description.

### BRIEF DESCRIPTION OF DRAWINGS

Various exemplary embodiments of systems and methods according to this invention will be described in detail, with reference to the following figures, wherein:

FIG. 1 shows one exemplary embodiment of a device incorporating one exemplary embodiment of systems and methods according to this invention:

FIG. 2 is a flowchart outlining one exemplary embodiment of a method for managing tasks, and task reminders according to this invention:

FIG. 3 is a flowchart outlining one exemplary embodiment of a method for entering or updating personal information of the flowchart shown in FIG. 1:

FIG. 4 is a flowchart outlining one exemplary embodiment of a method for activating an enter or edit name information menu of the method shown in FIG. 2:

FIG. 5 is one exemplary embodiment of a method for entering or editing address information menu of the method shown in FIG. 3:

FIG. 6 is a flowchart outlining one exemplary embodiment of a method for activating a maintain passwords menu of the method outlined in FIG. 2:

FIG. 7 is a flowchart outlining one exemplary embodiment of a method for maintaining system password information of the method shown in FIG. 6:

FIG. 8 is a flowchart outlining one exemplary embodiment of a method sign-off password information of the method outlined in FIG. 6:

FIG. 9 is a flowchart outlining one exemplary embodiment of a method for programming prompts of the method shown in FIG. 2:

FIG. 10 is a flowchart outlining one exemplary embodiment of a method for programming recurring prompts of the method outlined in FIG. 9:

FIG. 11 is a flowchart outlining one exemplary embodiment of a method for setting prompt data of the method outlined in FIG. 9:

FIG. 12 is a flowchart outlining one exemplary embodiment of a method for activating an activate selected sensors menu of the method outlined in FIG. 2:

FIG. 13 is a flowchart outlining one exemplary embodiment of a method for activating a review/sign-off prompt menu of the method outlined in FIG. 2:

FIG. 14 is a flowchart outlining one exemplary embodiment of a method for activating a review tasks menu of the method outlined in FIG. 13:

FIG. 15 is a flowchart outlining one exemplary embodiment of a method for activating a review all tasks menu of the method outlined in FIG. 14:

FIG. 16 is a flowchart outlining one exemplary embodiment of a method for activating a review completed tasks menu of the method outlined in FIG. 14:

FIG. 17 is a flowchart outlining one exemplary embodiment of a method for activating a review incomplete task menu of the method outlined in FIG. 14:

FIG. 18 is a flowchart outlining one exemplary embodiment of a method for activating a set time and date menu of the method outlined in FIG. 2:

FIGS. 19 and 20 are a flowchart outlining one exemplary embodiment of a method for presenting prompts to a user of the method outlined in FIG. 2:

FIG. 21 illustrates a first exemplary embodiment of a task management and reminder device according to this invention:

FIG. 22 illustrates one exemplary embodiment of a display device and various exemplary graphics displayable on the display device of FIG. 22:

FIG. 23 illustrates a second exemplary embodiment of a task management and reminder device according to this invention: and

FIG. 24 illustrates a third exemplary embodiment of a task management and reminder device according to this invention.

### DETAILED DESCRIPTION OF DISCLOSED EMBODIMENTS

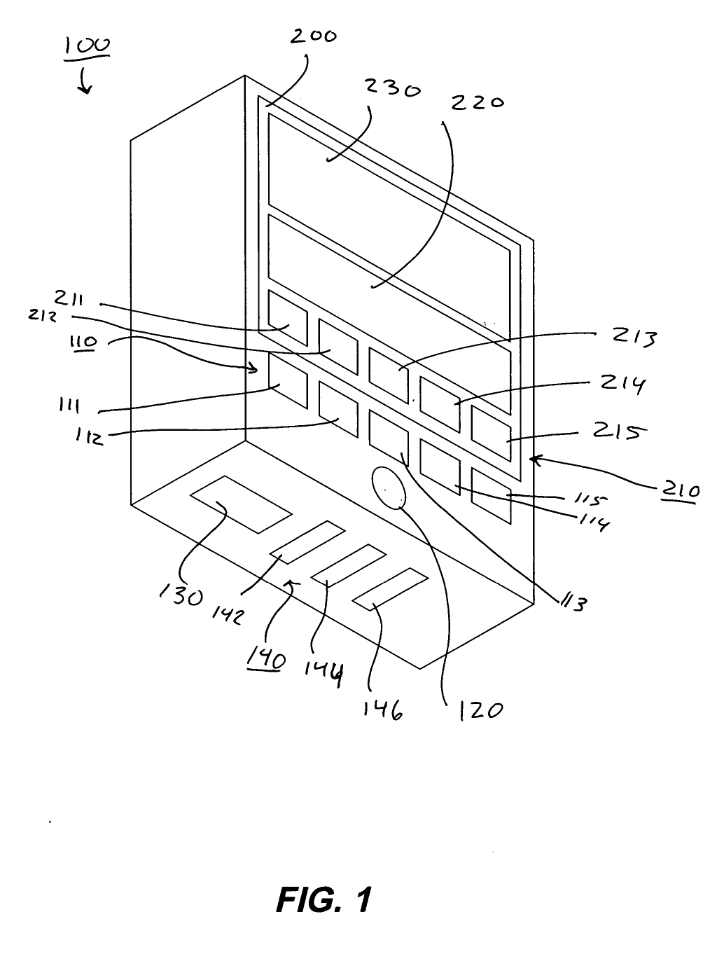

FIG. 1 illustrates one exemplary embodiment of a device, such as a digital clock, a digital CD player, a personal digital assistant, a laptop computer, a portable video game player or the like that is useable to implement various exemplary embodiments of systems and methods according to this invention. It should also be appreciated that a desktop personal computer can also be used to implement various exemplary embodiments of systems and methods according to this invention based on the following detailed description of the device shown in FIG. 1.

As shown in FIG. 1, the task and reminder managing device 100 includes a plurality of buttons 110, a microphone 120, a loud speaker 130, and a plurality of sensors 140, along with a display device 200. As shown in FIG. 1, in various exemplary embodiments, the buttons 110 include five buttons 111-115. It should be appreciated, however, that any other known or later developed device usable by a user of the task and reminder managing device 100 to generate an input signal to the implemented embodiment of a system for managing tasks and reminders according to this invention can be used in place of one or more of the buttons 111-115. As shown in FIG. 1, the sensors 140 include one or more of a motion sensor 142, a light sensor 144, and/or a sound sensor 146. It should be appreciated that any other known or later developed device that is able to sense an environmental parameter or variable that will typically change in response to the user coming in to the vicinity of the task and reminder managing device 100 can be used in addition to or in place of one more or all of the various sensors 142-146. It should also be appreciated that, in place of the sound sensor 146, the microphone 120 can be used both to record desired sounds as well as to sense such environmental sounds in order to generate an indication to the system for managing tasks and reminders that indicates that the user may have come into the vicinity of the task and reminder managing device 100.

In various exemplary embodiments, the display device 200 is any known or later developed display device, such as a cathode ray tube (CRT), a liquid crystal device (LCD), a thin film transistor display device, a plasma display device, a micro mirror array device, or the like.

It should be appreciated, in various exemplary embodiments, the display device 200 can also be an input device, such as a touch sensitive screen or any other known or later developed input device that can be implemented along with a display device.

As shown in FIG. 1, in various exemplary embodiments, the display screen 200 includes a menu display region 210, a first display region 220, and a second display region 230. In various exemplary embodiments, the menu display region 210 comprises a plurality of menu item regions 211-215, for example. In various exemplary embodiments, such as that shown in FIG. 1, each of the menu item regions 211-215 is associated with one of the input devices 111-115, respectively. In such exemplary embodiments, a menu item is displayed in each of the menu item regions 211-215. That menu item can then be selected using one of the selection devices 111-115 that is associated with that particular menu item region 211-215.

In various other exemplary embodiments, such as those incorporating a touch screen display device 200 or other display device 200 that can be used as an input device, each of the menu item regions 211-215 will display a particular menu item. That menu item can be selected by touching the screen of the display device 200 within the bounds of the particular menu item region 211-215. Of course, it should be appreciated that a boundary region could be provided around each of the menu item regions 211-215 to allow for less precision in the user's interaction with the display device 200. It should also be appreciated that, in such exemplary embodiments, it is possible, although not necessary, to omit the selection devices 111-115.

In still other exemplary embodiments, the selection devices 111-115 can be replaced with a pointer control device, such as a touch device that is commonly used with laptop computers and the like, along with one or more selection devices corresponding to mouse buttons or the like. In such exemplary embodiments, the touch device can be used to maneuver a pointer around the display device 200 and the one or more selection devices used to select a menu item when the pointer is within one of the menu item regions 211-215. Finally, it should be appreciated that any other known or later developed system method device or the like that is useable to allow a menu item to be selected can be used in place of, or in addition to, the various systems and methods outlined above.

In various exemplary embodiments, the first display region 220 can be used to display text associated with a particular task or reminder, a list of active tasks or reminders to be completed based on the current date and/or time, a list of completed tasks, a list of incentives, such as privileges, monetary awards, or other items or privileges the user values, and/or any other useable information that is desirably conveyed to the user. In various exemplary embodiments, the second display region 230 can be used to display a daily calendar, a weekly calendar, a monthly calendar, the time of day or any other systemic information that is desirably conveyed to the user or the supervisor.

It should be appreciated that, in various exemplary embodiments, the locations of the first and second display regions 220 and 230 can be altered as desired, such as placing them side by side, splitting one region into two portions and placing it on either side or top and bottom of the other region, arranging them vertically instead of horizontally or the like. It should further be appreciated that the first and second display regions 220 and 230 can be combined in to a single region. In yet other various exemplary embodiments, one or both of the first and second display regions 220 and 230 can be omitted.

As shown in FIG. 1, the task and reminder managing device 100 includes a microphone 120, a speaker 130 and various sensors 140. The microphone 120 is useable to record a spoken prompt, reminder or description of a particular task or reminder that has been entered into the task and reminder managing device 100. The speaker 130 is usable to play such recorded prompts, reminders or descriptions, along with other sounds, such as a pre-recorded or pre-determined sound usable to notify the user that an active task or reminder needs to be acknowledged. If the task and reminder managing device 100 incorporates an alarm clock or radio, the speaker 130 can be used to play an alarm sound and/or play the received radio signal. It should be appreciated that, when the speaker 130 is incorporated into the task and reminder managing device 100, various pre-recorded and/or pre-determined sounds can be associated with various events, such as active tasks or reminders that need to be acknowledged, tasks or reminders that need to be signed off on by a supervisor, and/or any other event that is desirably associated with a sound.

In the exemplary embodiment shown in FIG. 1, the sensors 140 includes a light sensor 142, a motion sensor 144 and a sound sensor 146. In various exemplary embodiments, the sensors 140 are used to determine when the user is potentially in the immediate vicinity of the task and reminder managing device 100, by sensing whether a light has been turned on, something has moved within the vicinity of the task and reminder managing device 100, and/or something has made a sound within the vicinity of the task and reminder managing device 100. For example, in various exemplary embodiments, it is anticipated that the task and reminder managing device 100 will be located in a child's bedroom. Typically, during the day, while the child is at school, the lights in the child's room will be off, there will be no motion in the room, and the room will be quiet. Accordingly, the sensors 140 can be used to keep the task and reminder managing device 100 from making sounds, such as playing announcements or the like, to an empty room.

Then, when the child returns home from school and enters the child's room, the child will typically turn on the lights, make noise, and/or move in the vicinity of the task and reminder managing device 100. As such, one or more of the sensors 140 will sense these actions. Based on the sensor outputs from the sensors 140, the task and reminder managing device 100 will assume that the child has returned home and any outstanding active tasks and/or reminders that the child needs to be reminded of are displayed and/or announced to the child, with the task and reminder managing device 100 using the sounds played by the speaker 130 that are associated with needing to review and/or acknowledge one or more such tasks or reminders, if any, along with any other known or later developed techniques for drawing the child's attention to the task and reminder managing device 100, such as flashing lights and the like. When a task reminder is non-verbal, presumably, this will cause the child to approach the task and reminder managing device 100, access the lists of tasks and/or reminders, acknowledge the reminders, and hopefully perform the tasks.

It should be appreciated that, in various exemplary embodiments, any one or more of the light sensor 142, motion sensor 144 and/or the sound sensor 146 can be omitted. Furthermore, it should be appreciated that, if the microphone 120 is implemented, the microphone 120 can also act as the sound sensor 146. In contrast, in various other exemplary embodiments, a separate sound sensor 146, that is distinct from the microphone 120, can be used.

It should be appreciated that the sensors 142-146 will detect light, motion, or sound, respectively, that occurs in the vicinity of the task and reminder managing device 100. Of course, it is always possible that such sensed events are not due to the child or other user coming within the vicinity of the task and reminder managing device 100. Rather, another person, a pet or the like may come within the vicinity of the task and reminder managing device 100. In such situations, the task and reminder managing device 100 will typically react in the same way as when the child or other user comes within the vicinity of the task and reminder managing device 100. However, because this other entity, whether it be another person, a pet or the like, does not know the child's password, the acknowledgments that task and reminder managing device 100 expects to receive will not be received. In various exemplary embodiments, the task and reminder managing device 100 is designed to treat such situations where the announcement of open tasks is made but not acknowledged, to be such a situation. In this case, the task and reminder managing device 100 will again hibernate, waiting for the user him or herself to come within the vicinity of the task and reminder managing device 100.

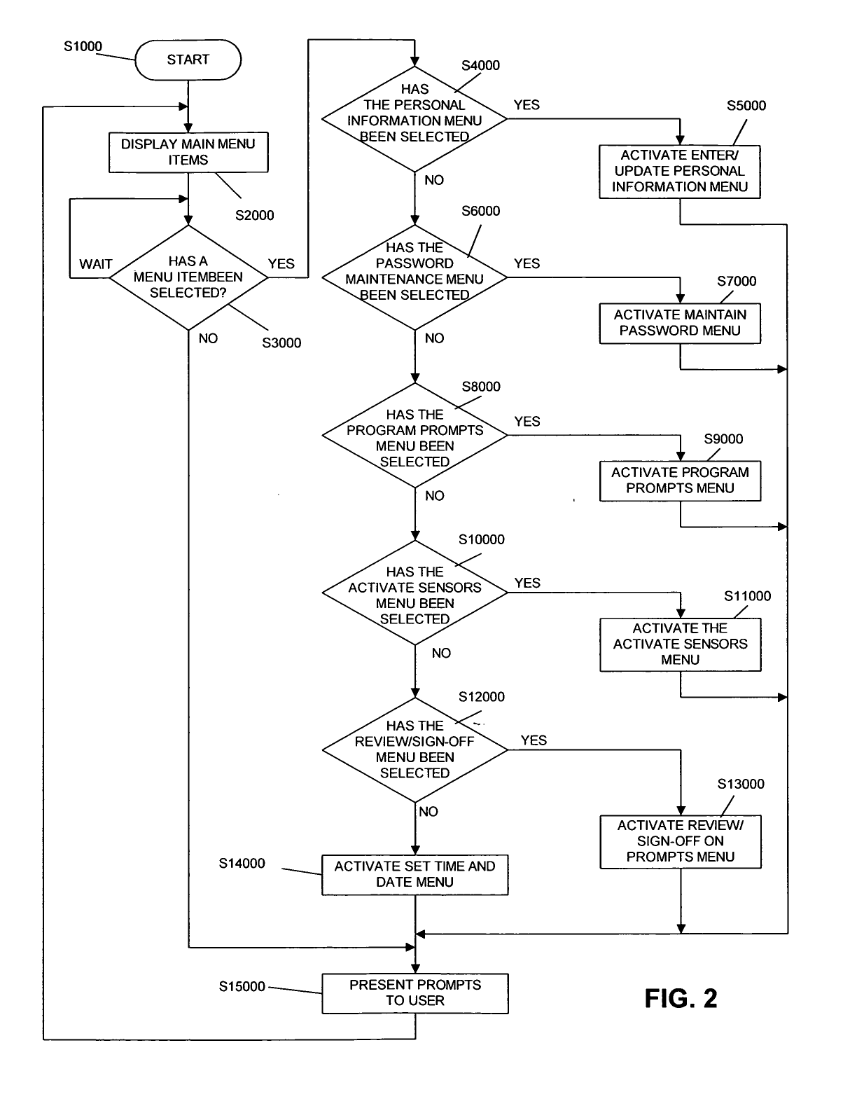

The task and reminder managing device 100 shown in FIG. 1 is, in various exemplary embodiments, implemented using a programmed general purpose microprocessor or microcontroller, possibly along with one or more memory devices and/or one or more peripheral integrated circuit elements. However, the task and reminder managing device 100 can also be implemented using an ASIC or other special purpose integrated circuit elements, a digital signal processor, a hardwired electronic or logic circuit such as a discrete element circuit, a programmable logic device such as a PLD, PLA, FPGA or PAL, or the like. In general, any device, capable of implementing a finite state machine that is in turn capable of implementing the flowcharts shown in FIGS. 2-20, can be used to implement the task and reminder managing device 100.

If implemented, the one or more memory devices can include any appropriate combination of alterable, volatile or non-volatile memory and/or non-alterable, or fixed, memory. If implemented, the alterable memory, whether volatile or non-volatile, can be implemented using any one or more of static or dynamic RAM, a writable or re-rewriteable optical disk and disk drive, a hard drive, flash memory or the like. Similarly, if implemented, the non-alterable or fixed memory can be implemented using any one or more of ROM, PROM, EPROM, EEPROM, an optical ROM disk, such as a CD-ROM or DVD-ROM disk, and disk drive or the like.

The selection devices and/or touch devices may be one or any combination of multiple input devices, such as a keyboard, a mouse, a joy stick, a trackball, a touch pad, a touch screen, a pen-based system, a microphone and associated voice recognition software, or any other known or later-developed device for inputting data and/or user commands to the stask and reminder managing device 100. It should be understood that the one or more selection devices and/or touch devices of FIG. 1 do not need to be the same type of device.

It should be understood that each of the flowcharts shown in FIGS. 2-20 can be implemented as software stored on a computer readable medium that is executable on a programmed general purpose computer, a special purpose computer, a microprocessor, a microcontroller, a digital signal processor or the like. It should also be understood that each of the flowcharts shown in FIGS. 2-20 can be implemented as portions, such as circuits, routines, applications, objects, procedures or managers, of a suitably programmed general-purpose computer, a special purpose computer, a microprocessor, a microcontroller or the like. Alternatively, each of the flowcharts shown in FIGS. 2-20 can be implemented as physically distinct hardware circuits within an ASIC, using a digital signal processor (DSP), using a FPGA, a PLD, a PLA and/or a PAL, or using discrete logic elements or discrete circuit elements. The particular form that any such logic elements, discrete circuit elements, circuits, routines, applications, objects, procedures or managers will take is a design choice and will be obvious and predictable to those skilled in the art. It should be appreciated that any such logic elements, discrete circuit elements,circuits, routines, applications, objects, procedures or managers do not need to be of the same design.

It should be appreciated that a routine, an application, a manager, a procedure, an object or the like can be a self-consistent sequence of computerized steps that lead to a desired result. These steps can be defined by and/or in one or more computer instructions stored in a computer readable medium, which should be understood to encompass using a carrier wave or the like to provide the software instructions to a processing device. These steps can be performed by a computer executing the instructions that define the steps. Thus, the terms “routine”, “application”, “manager”, “procedure”, and “object” can refer to, for example, a sequence of instructions, a sequence of instructions organized within a programmed-procedure or programmed-function, and/or a sequence of instructions organized within programmed processes executing in one or more computers. Such routines, applications, managers, procedures, objects or the like can also be implemented directly in circuitry that performs the procedure. Further, computer-controlled methods can be performed by a computer executing one or more appropriate programs, by special purpose hardware designed to perform the method, or any combination of such hardware, firmware and software elements.

FIG. 2 is a flowchart outlining one exemplary embodiment of a method for managing tasks and reminders according to this invention, which can be implemented using a device such as the task and reminder managing device 100 shown in FIG. 1. As shown in FIG. 2, operation of the method begins in step S1000, and continues to step S2000, where a set of main menu items are displayed to a user or supervisor. Then, in step S3000, a determination is made whether a main menu item has been selected. If not, and the main menu items have not been displayed for a predetermined time period, operation returns to step S3000. If none of the main menu items are selected within the predetermined time period, operation jumps from step S3000 to step S15000. Otherwise, if a main menu item is selected within the time period, operation continues to step S4000.

In step S4000, a determination is made whether a personal information menu item has been selected. If so, operation jumps to S5000. Otherwise, operation continues to step S6000. In step S5000, the enter/update personal information menu is activated. Operation then jumps to step S15000.

In step S6000, a determination is made whether a password maintenance menu item has been selected. If so, operation continues to step S7000. Otherwise, operation jumps to step S8000. In step S7000, a maintain password menu is activated. Operation then again jumps to step S15000.

In step S8000, a determination is made whether a program prompts menu item has been selected. If so, operations continue to step S9000. Otherwise, operation jumps to step S10000. In step S9000, a program prompts menu or function is activated or enabled. Operation then again jumps to step S15000.

In step S10000, a determination is made whether an activate selected sensors menu item has been selected. If so, operation continues to step S11000. Othewise, operation jumps to step 12000. In step S11000, an activate sensors menu is activated. Operation then again jumps to step S15000.

In step S12000, a determination is made whether a review/sign-off menu item has been selected. If so, operation jumps to step S13000. Otherwise, operation continues to step S14000. In step S13000, a review/sign-off on prompts menu is activated. Operation then jumps to S15000. In contrast, in step S14000, a set time and date menu is activated. Operation then continues to step S15000, where any active prompts are presented to the user. Operation then returns to step S2000.

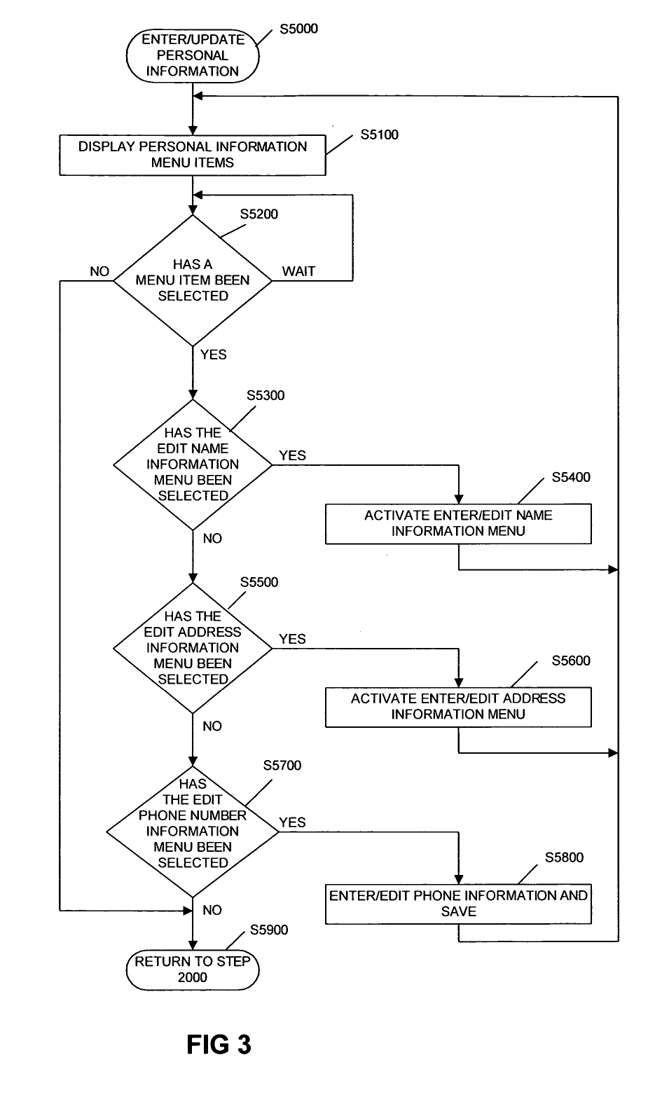

FIG. 3 outlines one exemplary embodiment of a method for activating the enter/update personal information menu. As shown in FIG. 3, one exemplary embodiment of the method for entering and/or updating personal information begins in step S5000, and continues to step S5100, where one or more personal information menu items are displayed as part of the personal information menu. Then, in step S5200, a determination is made whether a personal information menu item has been selected. If the personal information menu items have not been displayed for at least a predetermined period, operation returns from step S5200 to S5200 until the personal information menu items have been displayed for the predetermined period. Once the personal information menu items have been displayed for the predetermined period without a selection having been made, operation jumps from step S5200 to step S5900. Otherwise, if a personal information menu item is selected within the predetermined period, operation continues to step S5300.

In step S5300, a determination is made whether an edit name information menu item has been selected. If so, operation continues to step S5400. Otherwise, operation jumps to step S5500. In step S5400, an enter/edit name information menu and/or function is activated. Operation then returns to step S5100.

In step S5500, a determination is made whether an edit address information menu item has been selected. If so, operation continues to step S5600. Otherwise, operation jumps to step S5700. In step S5600, an enter/edit address information menu and/or function is activated. Operation then returns to step S5100.

In step S5700, a determination is made whether an edit phone number information menu item menu has been selected. If so, operation continues to step S5800, where the phone information is entered or edited and saved. Operation then returns to step S5100. In contrast, if the edit phone number information menu item is not selected, then the return to main menu menu item must have been selected. Accordingly, operation jumps from step S5700 to step S5900, where operation of the method again returns to step S2000.

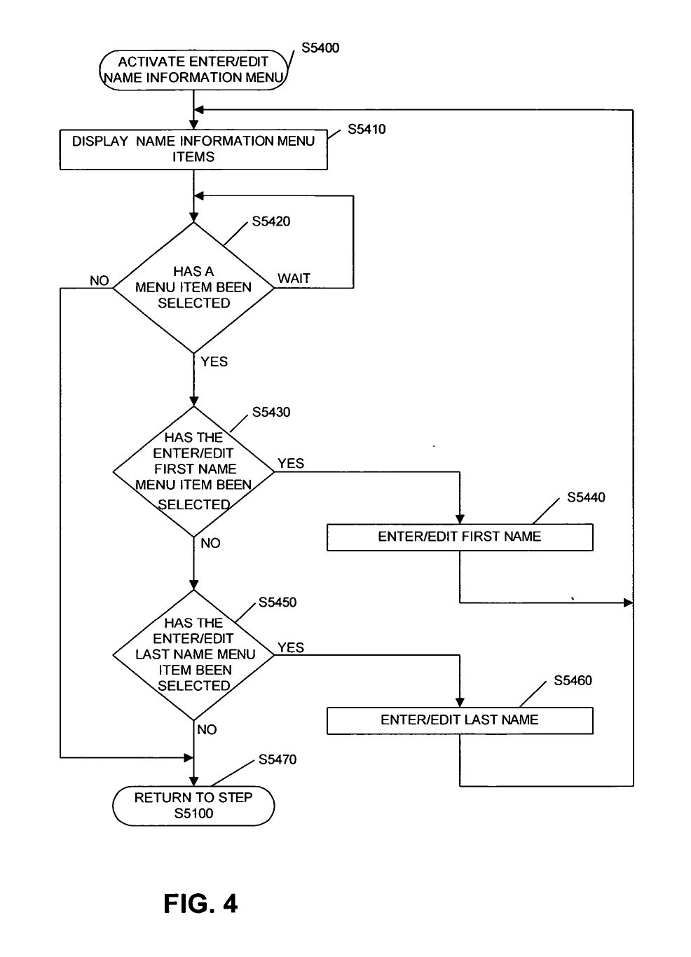

FIG. 4 outlines one exemplary embodiment of a method for activating the enter/edit name information menu item and/or function. As shown in FIG. 4, in various exemplary embodiments, operation of the method begins in step S5400, and continues to step S5410, where the name information menu items and/or functions are displayed. Next, in step S5420, a determination is made whether a name information menu item has been selected within a predetermined time period. If no name information menu items are selected within the predetermined period, operation jumps from step S5420 to step S5470. Otherwise, operation loops back to step S5420 until either one of the name information menu items is selected or the predetermined time period expires. When one of the name information menu items is selected within the predetermined time period, operation continues from step S5420 to step S5430.

In step S5430, a determination is made whether an enter/edit first name menu item has been selected. If so, operation continues to step S5440, where the first name information is entered or edited and saved. Operation then returns to step S5410.

Otherwise, operation jumps from step S5430 to step S5450. In step S5450, a determination is made whether an enter/edit last name information menu item has been selected. If so, operation continues to step S5460. Otherwise, the return to previous menu menu item has been selected. Accordingly, operation continues to step S5470. In step S5460, the last name information is entered or edited and saved. Operation then returns to step S5400. In contrast, in step S5470, operation of the method returns to step S5100.

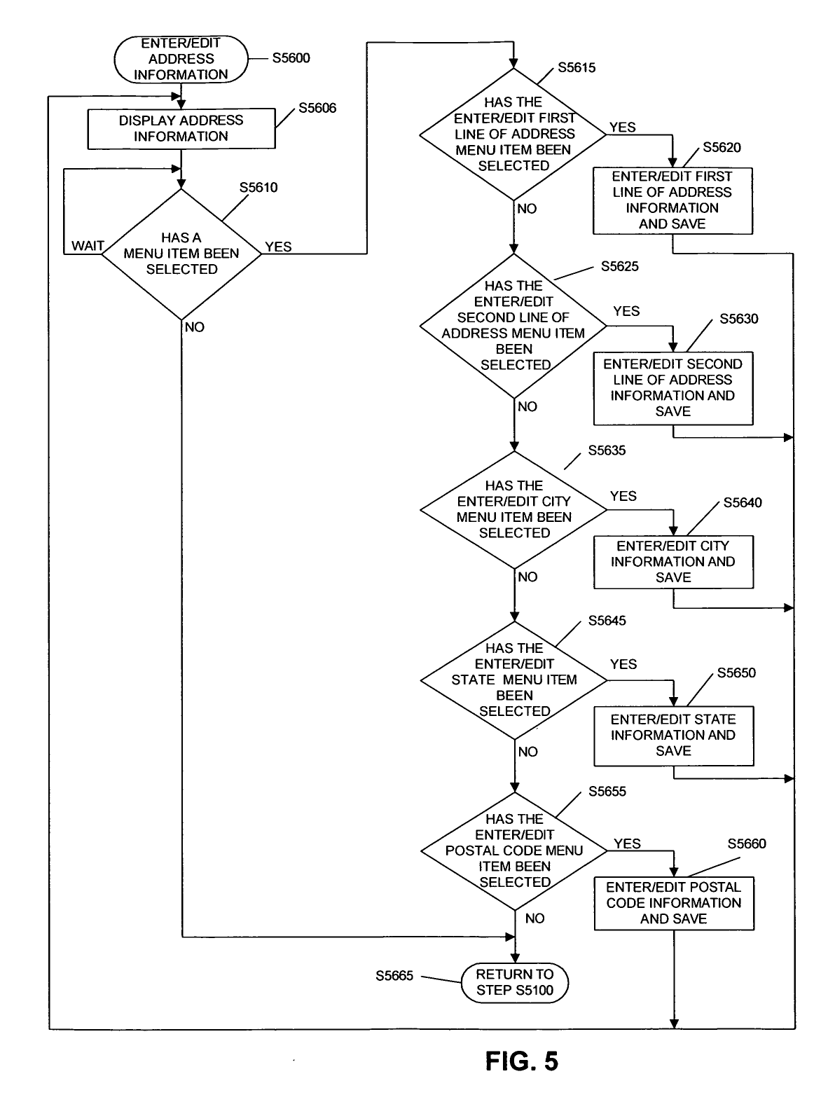

FIG. 5 is a flowchart outlining one exemplary embodiment of a method for activating the enter/edit address information menu and/or function. As shown in FIG. 5, in various exemplary embodiments, operation of the method begins in step S5600, and continues to step S5605, where the address information menu items and/or functions are displayed. Then, in step S5610, a determination is made whether an address information menu item has been selected in a predetermined time period. If no address information menu item is selected within the predetermined time period, operation jumps from step S5610 to step S5665. Otherwise, operation loops around step S5610 until either an address information item is selected or the predetermined time period has expired. Once an address information menu item is selected within the predetermined time period, operation of the method continues from step S5610 to S5615.

In step S5615, a determination is made whether an enter/edit first line of address menu item has been selected. If so, operation continues to step S5620. Otherwise, operation jumps to step S5625. In step S5620, the first line of the address information is entered or edited and saved. Operation then returns to step S5605.

In step S5625, a determination is made whether an enter/edit second line of address menu item has been selected. If so, operation continues to step S5630. Otherwise, operation jumps to step S5635. In step S5630, the second line of the address information is entered or edited and saved. Operation then jumps back to step S5610. Othewise, operation jumps to step S5635.

In step S5635, a determination is made whether an enter/edit city menu item has been selected. If so, operation continues to step S5640. Otherwise, operation jumps to step S5645. In step S5640, the city is entered or edited and saved. Operation then jumps back to step S5605.

In step S5645, a determination is made whether an enter/edit state menu item has been selected. If so, operation continues to step S5660. Otherwise, operation continues to step S5655. In step S5650, the state information is entered and/or edited and saved. Operation then jumps back to step S5605.

In step S5655, a determination is made whether an enter/edit postal code menu item has been selected. If so, operation continues to step S5660. Otherwise, the return to previous menu menu item has been selected and operation jumps to step S5665. In step S5660, the postal code information is entered and/or edited and saved. Operation then jumps back to step S5605.

In contrast, in step S5665, operation of the method returns to step S5100.

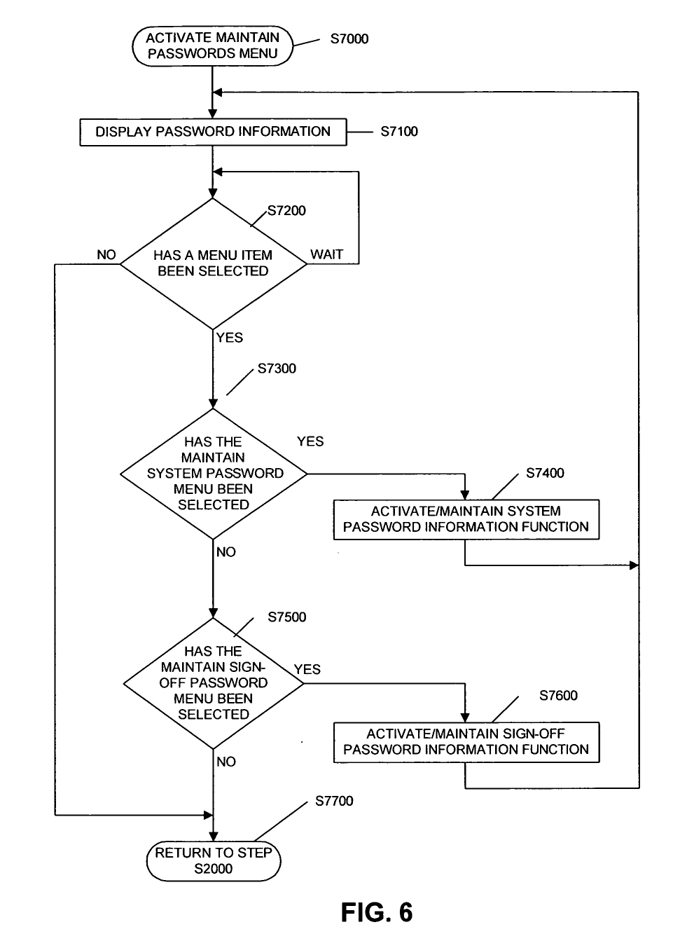

FIG. 6 outlines one exemplary embodiment of a method for activating the maintain password menu and/or function. As shown in FIG. 6, in various exemplary embodiments, operation begins in step S7000, and continues to step S7100. In step S7100, the password information menu items are displayed. Next, in step S7200, a determination is made whether a password information menu item has been selected within a predetermined time period. If not, operation jumps from step S7200 to step S7700. Otherwise, operation loops around step S7200 until a password information menu item is selected or the predetermined time period expires. Once a password information menu item is selected within the predetermined time period, operation continues from step S7200 to step S7300.

In step S7300, a determination is made whether a maintain system password menu item has been selected. If so, operation continues to step S7400. Otherwise, operation jumps to step S7500. In step S7400, a maintain system password information function is activated. Operation then returns to step S7100.

In step S7500, a determination is made whether a maintain sign-off password menu item has been selected. If so, operation continues to step S7600. Otherwise, operation jumps to step S7700. In step S7600, a maintain sign-off password information function is activated. Operation then jumps back to step S7100. In contrast, in step S7700, operation of the method returns to step S2000.

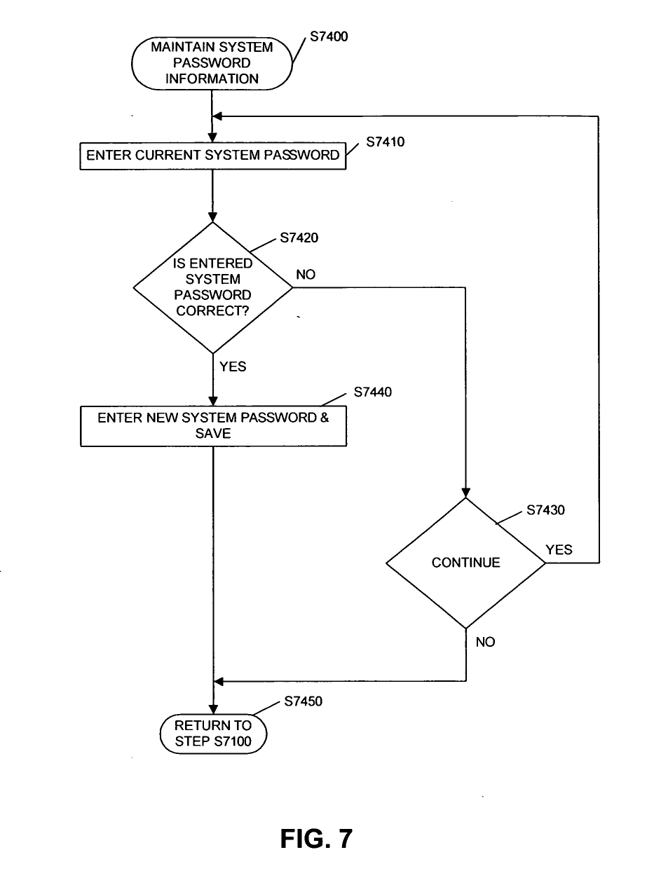

FIG. 7 outlines one exemplary embodiment of a method for maintaining system password information according to this invention. As shown in FIG. 7, in various exemplary embodiments, operation of the method begins in step S7400, and continues to step S7410. In step S7410, the user or supervisor is prompted to enter the appropriate system password. The system password allows the user or supervisor to add new prompts or reminders, modify previously added tasks or reminders that were added using that particular password, mark off particular tasks or reminders as having been completed or acknowledged, but does not allow the user or supervisor to sign off on tasks that the user has asserted that the user has completed. Once the user or supervisor has entered the appropriate system password, operation continues from step S7410 to step S7420.

In step S7420, a determination is made whether the entered system password is correct. If not, operation continues to step S7430. Otherwise, operation jumps to step S7440. In step S7430, the user or supervisor is advised that the entered password is incorrect and requested to indicate whether the user or supervisor wishes to continue or not. If the user or supervisor wishes to continue, operation jumps back to step S7410. Otherwise, operation jumps to step S7450.

In contrast, in step S7440, the supervisor or user is prompted to enter the new system password and the new system password is saved. Operation then continues to step S7450, where operation of the method returns to step S7100.

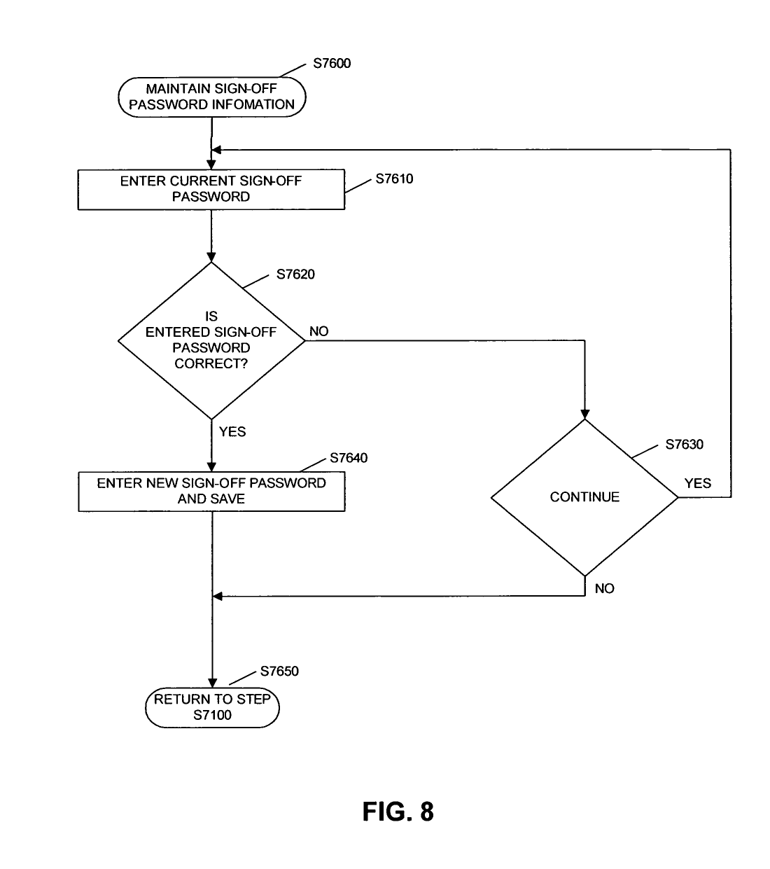

FIG. 8 outlines one exemplary embodiment of a method for maintaining sign-off password information. As shown in FIG. 8, in various exemplary embodiments, operation of the method begins in step S7600, and continues to step S7610, where the supervisor enters a current appropriate sign-off password. It should be appreciated that, in various exemplary embodiments, only the supervisor (or supervisors) will have the sign-off password. It should also be appreciated that the supervisors sign-off password and the supervisors system password can be the same password, and can be treated as a single password. By separating the regular system privileges from the sign-off privileges the user, such as the child, attempting to improperly sign-off on tasks that have not actually completed can be avoided.

In step S7620, a determination is made whether the entered sign-off password is correct. If not, operation continues to step S7630. Otherwise, operation jumps to step S7640. In step S7630, the supervisor or user is provided with a message that the entered sign-off password is incorrect and requested to indicate whether the user or supervisor wishes to continue or not. In step S7630, if the user or supervisor wishes to continue, operation returns to step S7610. Otherwise, operation jumps to step S7650.

In step S7640, the user is prompted to enter the new sign-off password. Once the user enters the new sign-off password it is saved and operation continues to step S7650, or operation returns to step S7100.

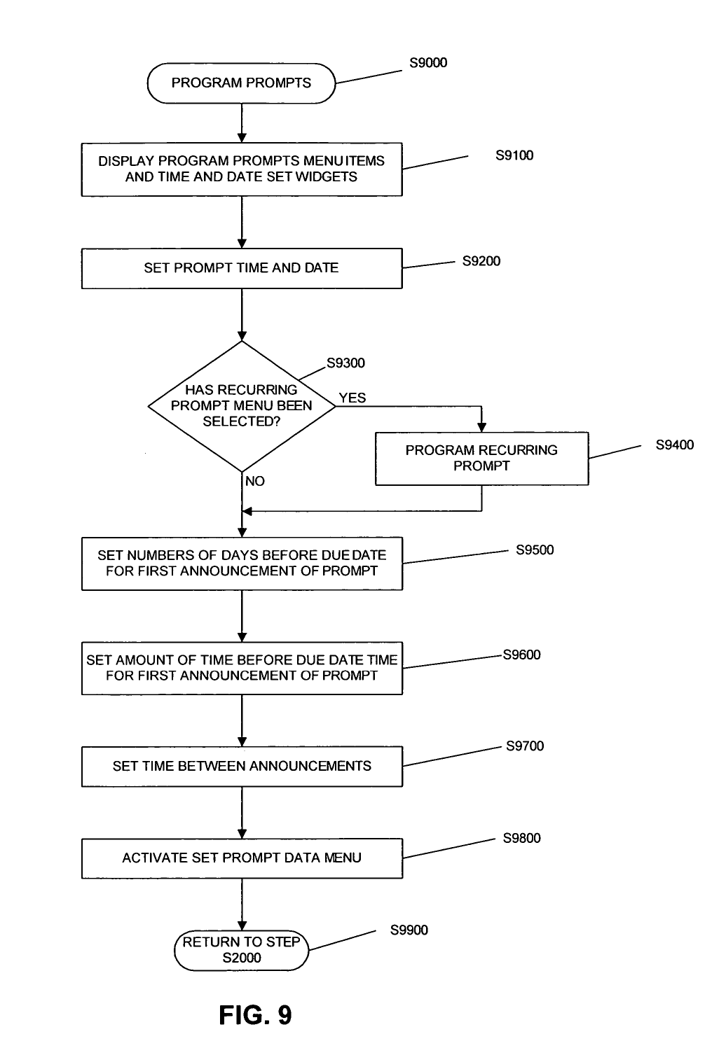

FIG. 9 outlines one exemplary embodiment of a method for programming prompts according to this invention. As shown in FIG. 9, in various exemplary embodiments, the method begins in step S9000 and continues to step S9100, where the program prompts menu items and time and date set widgets are displayed. It should be appreciated that the program prompts menu is used to program or create or edit tasks and reminders, and is not used to display tasks and reminders, nor notify the user of outstanding tasks or reminders that need to be acknowledged and/or completed. Operation then continues to step S9200.

In step S9200, the time and/or date for the prompt to be programmed is set using the time and/or date set widgets. Then, in step S9300, a determination is made whether the recurring prompt menu and/or function has been selected for the current prompt being programmed. If so, operation continues to step S9400. Otherwise, operation jumps directly to step S9500. In step S9400, the recurring prompt menu or function is activated. Operation then continues to step S9500.

In step S9500, the number of days for the first announcement of the task or reminder, i.e., the number of days before the due date set in step S9200, is set using an appropriate user interface widget. Next, in step S9600, the amount of time for the first announcement of the task or reminder, before the due time set in step S9200, is set using an appropriate user interface widget. Then, in step S9700, the time between announcements is set using an appropriate user interface widget. Thus, it should be appreciated that, in steps S9500-S9700, the user or supervisor is able to indicate how far, in advance of the due date of the prompt, that the user is to be reminded and how often the user is to be reminded. For example, the first reminder for a particular task could be set to begin one week before the task or reminder is due and to remind the user every day. If the task is due to be completed at eight o'clock at night, i.e., before the user goes to bed, the time for the announcement can be set at three o'clock, i.e., just before or as the user returns from school, around dinner time, and/or after dinner but well before bed time. This allows the user to be prompted daily as and/or after the user returns from school each day for the week prior to the due date for the task. This may be appropriate, for example, for a task such as completing an important school project. Operation then continues to step S9800, where the set prompt data menu and/or function is activated. Next, in step S9900, operation of the method returns to step S2000.

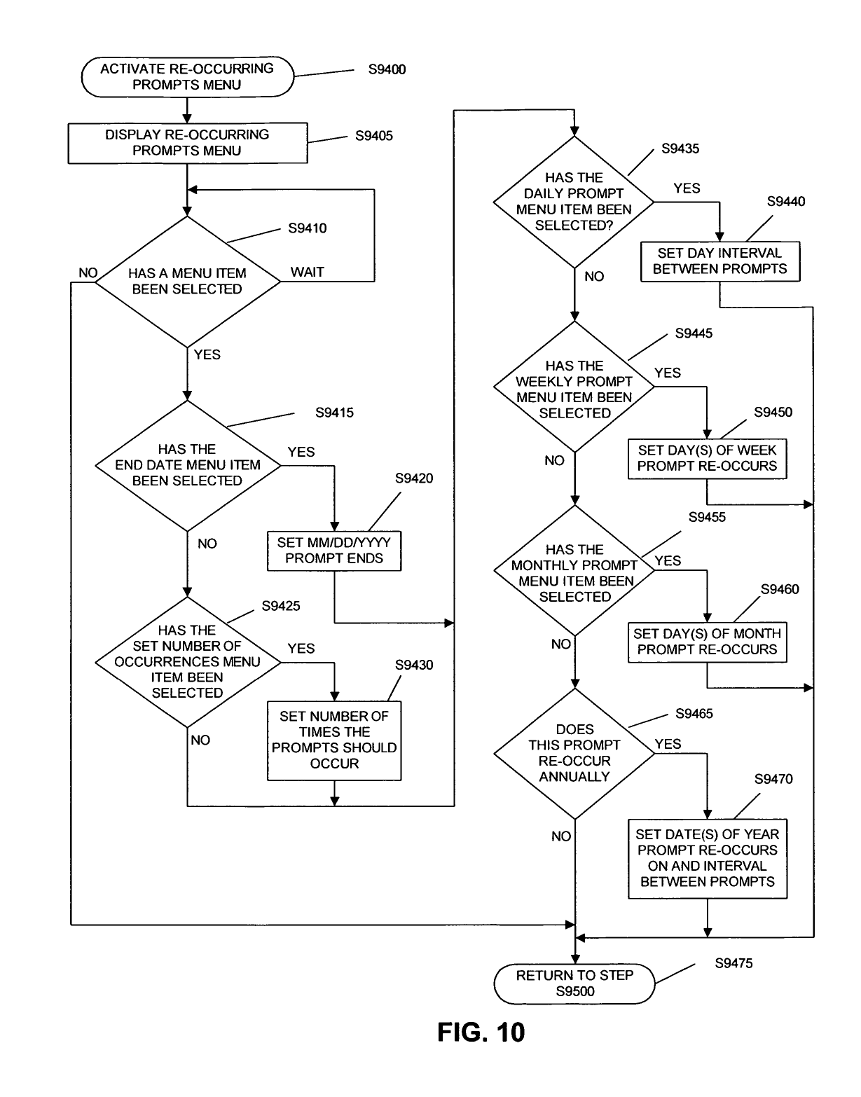

FIG. 10 is a flowchart outlining one exemplary embodiment of a method for programming recurring prompts according to this invention. As shown in FIG. 10, in various exemplary embodiments, operation of the method begins in step S9400, and continues to step S9405, where the recurring prompt menu items are displayed. Then, in step S9410, a determination is made whether a recurring prompt menu item has been selected within a predetermined time period. If no recurring prompt menu has been selected within the predetermined time period, operation of the method jumps to step S9475. Otherwise, operation of the method loops around step S9410 until either a recurring prompt menu item is selected or the predetermined time period expires. Once a recurring prompt menu item is selected within the predetermined time period, operation continues from step S9410 to step S9415.

In step S9415, a determination is made whether the end date menu item and/or function has been selected. If so, operation continues to step S9420. Otherwise, operation jumps to step S9425. In step S9420, the user is prompted to set the month day and year that the recurring task or reminder is to end. Operation then continues to step S9435.

In step S9425, a determination is made whether the set number of occurrence menu item and/or function has been selected. If so, operation continues to step S9430. Otherwise, operation jumps directly to step S9435. In step S9430, the user is prompted to set the number of times the task or reminder should reoccur. It should be appreciated that the start date for the reoccurring prompt is the date set in step S9100. It should be appreciated that, if neither the end date menu item or number of occurrences menu item is selected, the recurring task or reminder will reoccur indefinitely until it is deleted from the system. Otherwise, the reoccurring task or reminder will be automatically deleted from the system after the last occurrence is signed off on or the ending month, day and year passes.

It should further be appreciated that, in various exemplary embodiments, the reoccurring prompt menu items are displayed in two tiers, with the ending date or number of occurrences menu items along with a continue menu item displayed first to require the user to indicate the ending date or number of occurrences before continuing. It should be appreciated that the particular exemplary embodiment outlined in FIG. 10 corresponds to this two tiered menu system. In various other exemplary embodiments, all of the menu items discussed with respect to FIG. 10 can be displayed at the same time. In such exemplary embodiments, the frequency of the reoccurring prompt can be programmed before or interspersed with the ending conditions. In contrast, in the exemplary embodiment shown in FIG. 10, the ending conditions are programmed before the reoccurrence frequency is programmed.

In step S9435, a determination is made whether the daily prompt menu item has been selected. If so, operation continues to step S9440. Otherwise, operation jumps to step S9445. In step S9440, upon selecting the daily prompt menu item, the user is presented with a series of one or more graphical user interface widgets that allow the user to define the day interval between the reoccurring task or reminder. By this, the user can indicate whether the reoccurring task/reminder is to reoccur daily, is to reoccur every other day, every third day, every fourth day, or any integer number of days between the reoccurring task or reminder. Once the user has indicated the interval and days between the reoccurring task or reminder, i.e. the task frequency, operation jumps to step S9475.

In step S9445, a determination is made whether the weekly prompt menu item has been selected. If so, operation continues to step S9450. Otherwise, operation jumps to step S9455. In step S9450, because the weekly menu item has been selected, the user is presented with one or more graphical user interface widgets that allow the user to indicate which days of the week the user wishes the task or reminder to reoccur. For example, for a school-related task or reminder, the reminder can be programmed to reoccur every weekday, Monday/Wednesday/Friday, Tuesday/Thursday, Sunday/Tuesday/Thursday (for homework due Monday/Wednesday/Friday), or the like. If the user programs only a single day, this is equivalent to selecting a reoccurrence frequency of seven days using the daily prompted menu item. Once the user has completed programming the weekly reoccurring task or reminder, operation jumps to step S9475.

In step S9455, a determination is made whether the monthly prompt menu item has been selected. If so, operation continues to step S9460. Otherwise, operation jumps to step S9465. In step S9460, because the monthly prompt menu item has been selected, the user is presented with one or more graphical user interface widgets that allow the user to indicate a particular date, such as the first, the second, the third, etc. day of a month, a particular day occurrence within a month, such as the first Monday, the third Wednesday, the last Saturday, or the like within the month and indicate whether that task is to reoccur monthly, bimonthly, quarterly, or any other integer interval between months. Once the user has completed programming the day or date during the month and the interval between months, operation continues to S9475.

In step S9465, a determination is made whether the user has selected the yearly prompt menu item. If so, operation continues to step S9470. Otherwise, because the user has selected the cancel menu item, operation jumps directly from step S9465 to step S9475. In step S9470, the user is presented with one or more graphical user interface widgets that allow the user to select the date within the year and the number of years between each task or reminder. For example, if the task or reminder is a birthday the user wishes to be reminded of the interval will be set to zero years, requiring the user to be reminded of the task or reminder every year. In contrast, if the task is a five or ten year reunion or the like, the yearly interval would be set to for example five or ten years. Once the user has finished indicating the day of the year and the reminder interval, operation continues to step S9475.

In step S9465, by selecting the cancel menu item, the user effectively cancels the reoccurring nature of the task or reminder so that the user will be reminded of the task reminder only a single time. In step S9475, operation of the method returns to step S9500.

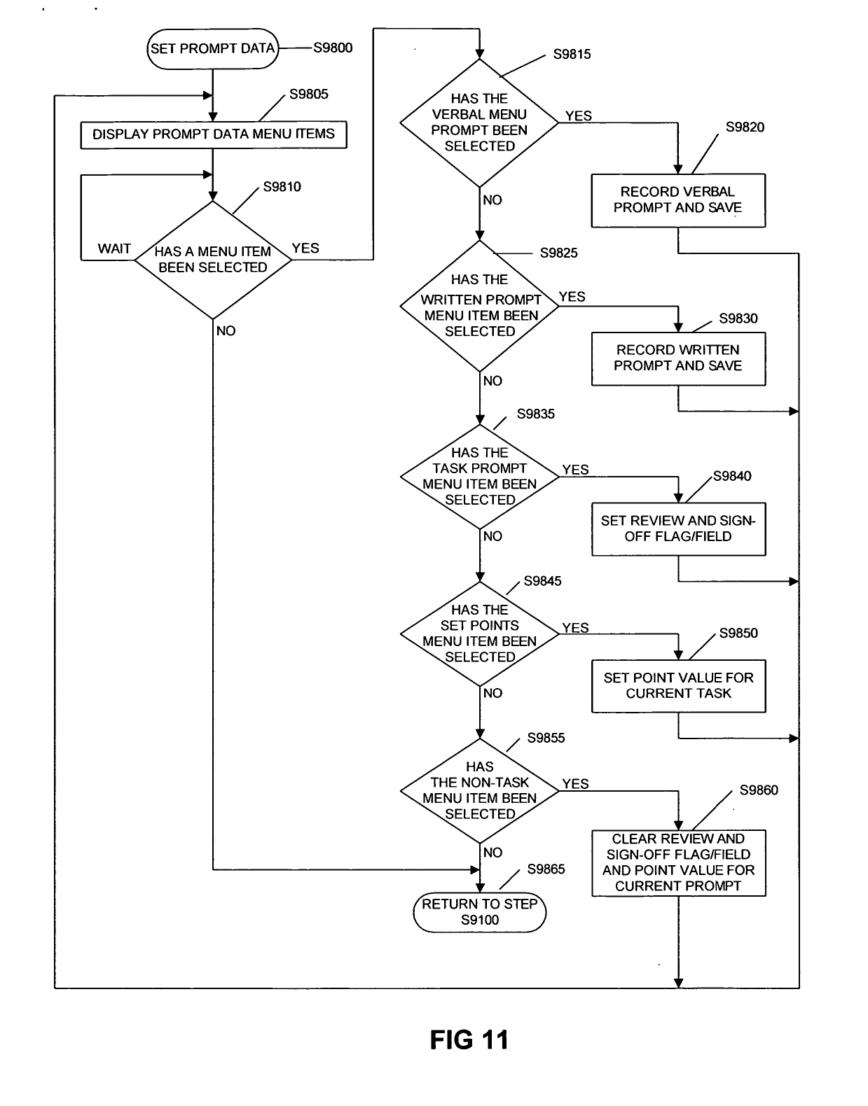

FIG. 11 is a flowchart outlining one exemplary embodiment of a method for setting the prompt data according to this invention. As shown in FIG. 11, in various exemplary embodiments, operation of the method begins in step S9800, and continues to step S9805, where the prompt data menu items are displayed. Next, in step S9810, a determination is made whether a menu item has been selected within a predetermined time period. If not, operation jumps from step S9810 to step S9865. Otherwise, the method loops around step S9810 until either one of the prompt data menu items is selected within the predetermined time period or the predetermined time period expires. Once one of the prompt data menu items is selected within the predetermined time period, operation continues from step S9810 to step S9815.

In step S9815, a determination is made whether the verbal prompt menu item has been selected. If so, operation continues to step S9820. Otherwise, operation jumps to step S9825. In step S9820, the user is presented with one or more graphical user interface widgets and/or text that allows the user to record the verbal prompt and save it. Operation then jumps back to step S9805.

In step S9825, a determination is made whether a written prompt menu item has been selected. If so, operations continue to step S9830. Otherwise, operation jumps to step S9835. In step S9830, the user is presented with one or more graphical user interface widgets and/or text that allow the user to create a written prompt and save it. Operation then again returns to step S9805.

In step S9835, a determination is made whether the task prompt menu item and/or function has been selected. If so, operation continues to step S9840. Otherwise, operation jumps to step S9845. In step S9840, the type of the task or reminder being programmed is set to a task rather than a reminder. It should be appreciated that a task differs from a reminder in that a task obligates the user to complete some physical action, such as a chore, the user's homework, or the like. A task also is something that the supervisor can review and confirm as to whether the task has been completed to the supervisor's satisfaction. Thus, when the task prompt menu item has been selected, in step S9840, a review and sign-off flag or field is set, requiring the user to indicate whether the user believes the user has completed the task, and requires the supervisor to sign off on the task, indicating that the task was in fact completed to the supervisors satisfaction. When the review and sign-off flag or field is not set, the programmed task or prompt is merely a reminder, which requires that the user acknowledge receiving the reminder, but does not obligate the user to perform any actions in response to that reminder. Operation then again returns to step S9805.

However, it should be appreciated that, in various other exemplary embodiments, as indicated in FIG. 11, rather than returning to step S9805, operation can continue from step S9840 directly to step S9850, such that the user or supervisor who is creating the prompt is immediately provided with the opportunities to set an incentive for that task.

In step S9845, a determination is made whether the set points menu item and/or function has been selected. If so, operation continues to step S9850. Otherwise, operation jumps to step S9855. In step S9850, the user is provided with one or more graphical user interface widgets and/or text that guide the user through setting a point or other incentive value for the current task being programmed. It should be appreciated that the points or other incentive that can be created can include one or more of a set monetary award, a privilege, such as watching a certain amount of television or being able to play a certain amount of computer or video games, or merely “points”, i.e. non-monetary value that can be exchanged for money and/or privileges such as watching t.v., playing video games, playing computer games or the like. Operation then again returns to step S9805.

In step S9855, a determination is made whether the non-task menu item and/or function has been selected. If so, operation jumps to step S9860. Otherwise, the return menu item and/or function has been selected and operation jumps to step S9865. In step S9860, if the user has previously set either or both of the review and sign-off flag or field, or the point value, because the prompt being programmed was a task, but the user wishes to modify the prompt to change it from a task to merely a reminder, in step S9860, the review and sign-off flag or field and the point value for the current prompt are cleared, converting it from a task to a reminder. It should be appreciated that this menu item and/or function would typically be used when editing a previously created prompt, rather than one programming a new prompt. However, this menu item and/or function can be used when a prompt was misprogrammed as a task rather than a reminder. In contrast, in step S9865, operation of the method returns to step S9100.

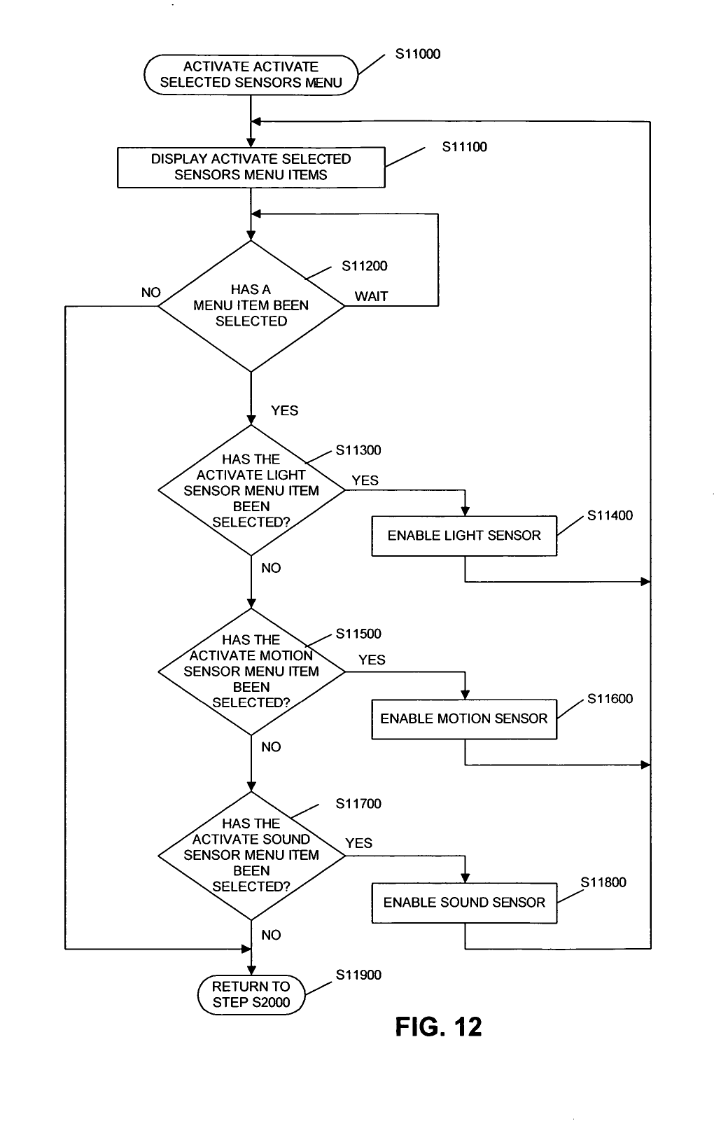

FIG. 12 is a flowchart outlining one exemplary embodiment of a method for activating the activate selected sensors menu item and/or function according to this invention. As shown in FIG. 12, in various exemplary embodiments, operation of the method begins in step S11000 and continues to step S11100, where the activate selected sensors menu items are displayed. Then, in step S11200, a determination is made whether an activate selected sensors menu item has been selected within a predetermined time period. If not, operation jumps from step S11200 to step S11900. Otherwise, operation of the method continues to loop around step S11200 until one of the activate selected sensor menu items is selected or the predetermined time period expires. Once an activate selected sensor menu item is selected within the predetermined time period, operation continues from step S11200 to step S11300.

In step S11300, a determination is made whether the activate light sensor has been selected. If so, operation continues to step S11400. Otherwise, operation continues to step S11500. In step S11400, the light sensor is enabled. Operation then jumps back to step S11100.

In step S11500, a determination is made whether the activate motion sensor menu item has been selected. If so, operation continues to step S11600. Otherwise, operation continues to step S11700. In step S11600, the motion sensor is enabled. Operation then again returns to step S11100.

In step S11700, a determination is made whether the activate sound sensor menu item has been selected. If so, operation continues to step S11800. Otherwise, operation jumps to step S11900. In step S11800, the sound sensor is enabled. Operation then again returns to step S11100. In contrast, in step S11900, operation of the method returns to step S2000.

It should be appreciated that, in the method outlined with respect to FIG. 11, one or more of these steps can be omitted, depending on which, if any, of the light sensor, motion sensor, and/or sound sensors are implemented. Additionally, if the sound sensor is implemented using the microphone, enabling the sound sensor comprises, in various exemplary embodiments, waiting for a signal to come from the microphone when the system is in a sleep or hibernation mode. When the system is not in a sleep or hibernation mode, a microphone is used to record verbal prompts, but, even if enabled, is not used as the sound sensor. In contrast, when the system is in a sleep or hibernation mode, the microphone is used as the sound sensor, but is not used to record sounds.

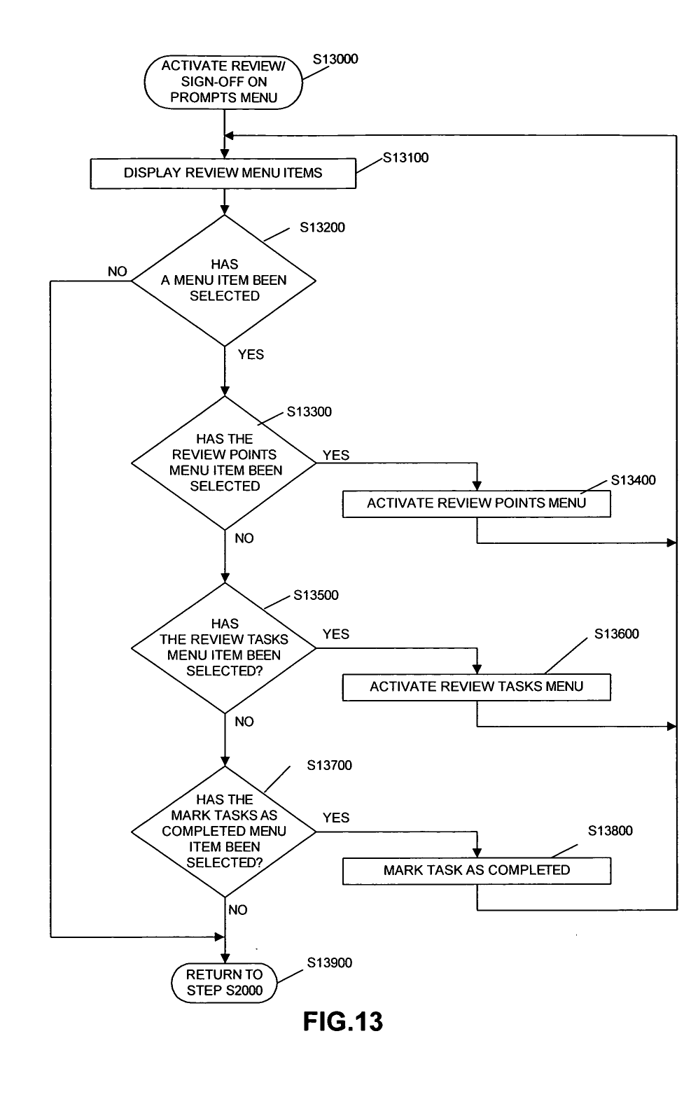

FIG. 13 is a flowchart outlining one exemplary embodiment of a method for activating the review/sign-off/on prompts menu. As shown in FIG. 13, operation of the method begins in step S13000, and continues to step S13100, where the review menu items are displayed. Then, in step S13200, a determination is made whether a review/sign-off menu item has been selected within a predetermined time period. If not, operation jumps to step S13900. Otherwise, operation continues to loop around step S13200 until a review/ sign-off menu item is selected within the predetermined time period or the predetermined time period expires. Once a review/sign-off menu item is selected within the predetermined time period, operation continues from step S13200 to step S13300.

In step S13300, a determination is made whether a review points menu item has been selected. If so, operation continues to step S13400. Otherwise, operation continues to step S13500. In step S13400, the review points menu is activated. In various exemplary embodiments of step S13400, the user is presented with a graphical user interface comprising text and/or widgets that allows the user to select a time period. Once the user has selected the time period the user can determine the amount of points or other incentives that were earned during the defined time period. Operation then returns to step S13100.

In step S13500, a determination is made whether the review tasks menu item has been selected. If so, operation continues to step S13600. Otherwise, operation continues to step S13700. In step S13600, the review tasks menu is activated. Operation then again returns to step S13100.

In step S13700, a determination is made whether the mark tasks as completed menu item has been selected. If so, operation continues to step S13800. Otherwise, operation jumps to step S13900. In step S13800, one or more tasks can be marked as completed. Operation then returns to step S13100. In contrast, in step S13900, operation of the method returns to step S2000.

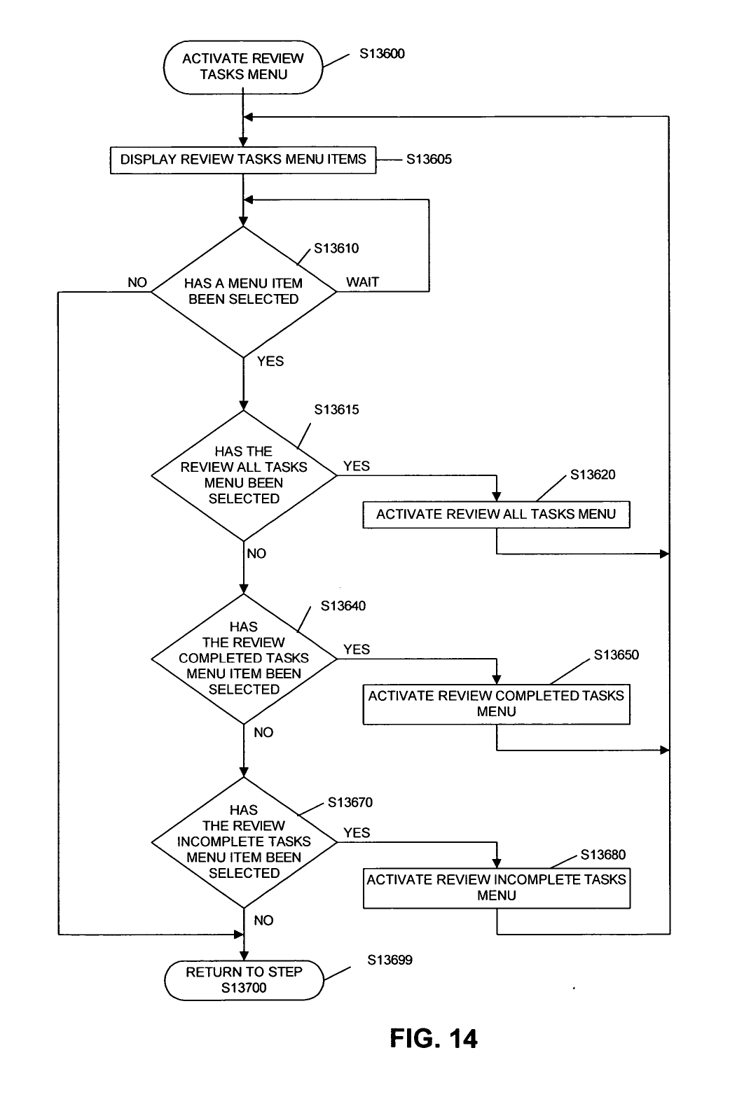

FIG. 14 is a flowchart outlining one exemplary embodiment of a method for activating the review tasks menu according to this invention. As shown in FIG. 14, in various exemplary embodiments, operation of the method begins in step S13600 and continues to S13605, where the review task menu items are displayed. Next, in step S13610, a determination is made whether a menu item has been selected within a predetermined time period. If not, operation jumps from step S13610 to step S13699. Otherwise, operation loops around step S13610 until either one of the review task menu items is selected within the predetermined time period or the predetermined time period expires. Once a review task menu item is selected within the predetermined time period, operation continues from step S13610 to step S13615.

In step S13615, a determination is made whether the review all tasks menu item has been selected. If so, operation continues to step S13620. Otherwise, operation jumps to step S13640. In step S13620, the review all tasks menu and/or function is activated. Operation then returns to step S13605.

In step S13640, a determination is made whether the review completed task menu item has been selected. If so, operation continues to step S13650. Otherwise operation continues to S13670. In step S13650, the review completed task menu and/or function is activated. Operation then returns to step S13605.

In step S13670, a determination is made whether the review uncompleted task menu item has been selected. If so, operation continues to step S13680. Otherwise, the return menu item has been selected and operation jumps to step S13699. In step S13680, the review incomplete task menu and/or function is activated. Operation then returns to step S13605. In contrast, in step S13699, operation returns to step S13700.

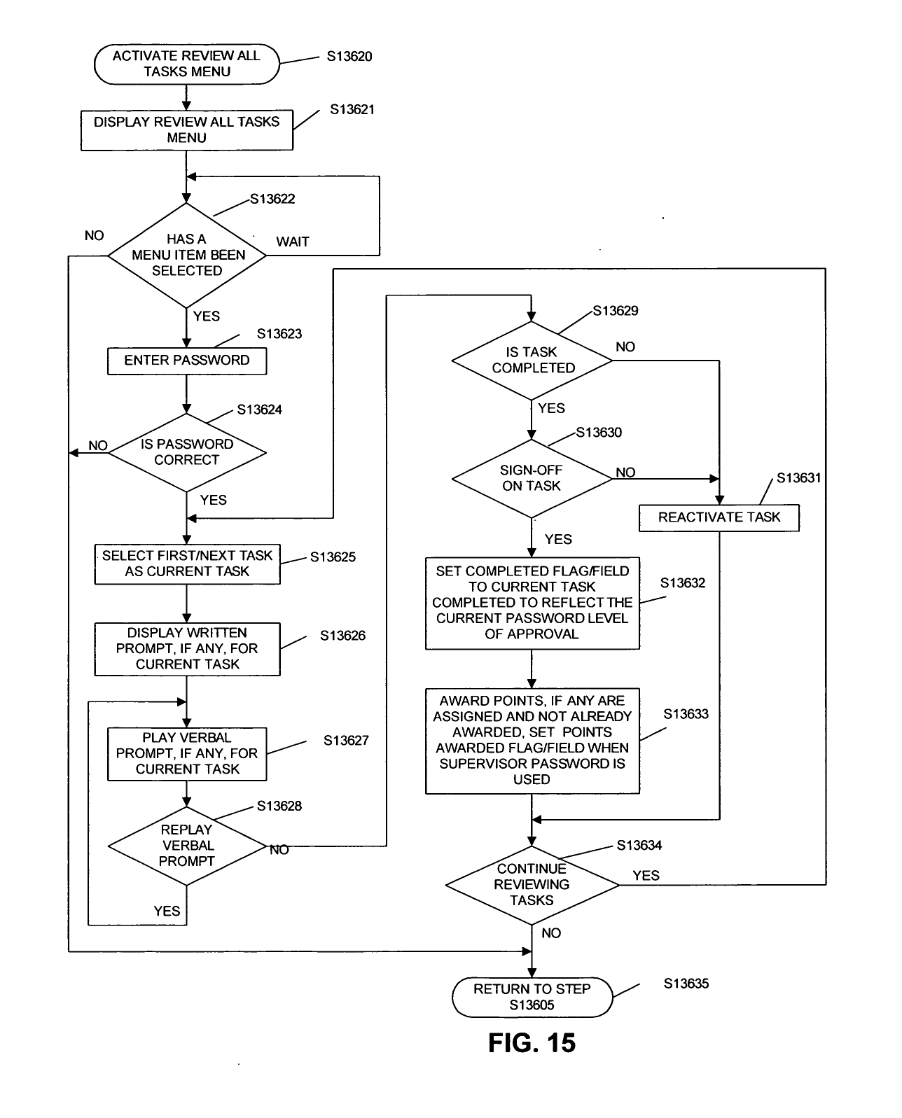

FIG. 15 outlines one exemplary embodiment of the method for activating the review all tasks menu and/or function, according to this invention. As shown in FIG. 15, in various exemplary embodiments, operation of the method begins in step S13620, and continues to step S13621, where the review all tasks menu items are displayed. Then, in step S13622, a determination is made whether a menu item has been selected within a predetermined time period. If not, operation jumps from step S13622 to step S13635. Otherwise, operation continues to loop around step S13622 until either one of the review all tasks menu items is selected within the predetermined time period or the predetermined time period expires. Once a review all task menu item is selected within the predetermined time period, operation continues to step S13623, where the user is prompted to enter the system or sign-off password. Next, in step S13624, a determination is made whether the password is correct. If so, operation continues to step S13625. Otherwise, operation jumps to step S13635.

In step S13625, a first or next task is selected as a current task. It should be appreciated that, because all of the tasks are being reviewed, all tasks, whether completed, incomplete, signed off or not, that are currently programmed and stored in the task management and reminder device are reviewed. It should be appreciated that these tasks can be reviewed in any desired order, and graphical user interface widgets can be provided to the user as part of step S13625 to allow that desired order to be used when selecting the tasks. It should be appreciated the desired order can include earliest to latest, latest to earliest, highest point total to lowest point total, tasks before reminders, reminders before a tasks, signed off before completed before incomplete or visa versa or any other desired order.

Next, in step S13626, the written prompt, if any, is displayed for the current task. Then, in step S13627, the verbal prompt, if any, for the current task is played. Next, in step S13628, a determination is made whether the user wishes to have the verbal prompt, if any, replayed. If so, operation returns to step S13627. Otherwise, operation continues to step S13629. Of course, if there are not any verbal prompts recorded for the current task, this step can be skipped.

In step S13629, a determination is made whether the current task is completed. It should be appreciated that the particular actions taken in this step will differ depending on whether the entered password was the system password or the sign-off password. In particular, the exemplary embodiment shown in FIG. 15 illustrates the method used when the sign off password has been entered. When the sign-off password has been entered, in step S13629, a determination is made whether the user has set the task completed flag or field, thus indicating that the user believes that this task has been completed. If the task has not been completed, operation jumps to step S13631. Otherwise, operation continues to step S13630.

In step S13630, because the sign-off password has been entered, a determination is made whether the supervisor has signed off on the task. In various exemplary embodiments, this comprises displaying a message to the supervisor requesting the user indicate whether or not the supervisor signs off on the task. If the task is not signed off on, operation continues from step S13630 to step S13631. Otherwise, because the task has been completed and signed-off on, operation jumps to step S13632. In step S13631, either because the task was not marked as completed by the user or because the supervisor did not sign off on the task as actually having been completed, the task is reactivated by clearing any set completed flags or the like. Reactivating the task can also include one or more of adding the reactivating the task to the task list, scheduling the prompts programmed into the system for this task or the like. Operation then jumps to step S13634.

In contrast, in steps S13632, the completed flag or field is set to indicate that the current task has been completed based on the level of approval associated with the password entered instep S13623. Next in step S13633, the defined incentive, such as points, a monetary award, an award of privileges or the like, if any points are assigned and not already awarded to this task, are awarded and the points awarded flag or field for this task is set. Operation then continues to step S13634, where a determination is made whether the user or supervisor wishes to continue reviewing tasks. If so, operation jumps back to step S13625. Otherwise, operation continues to step S13635, which returns control to step S13605.

It should be appreciated that, in various exemplary embodiments where the system password rather than the sign-off password has been entered, steps S13630 and S13632 can be omitted, as the user, rather than the supervisor, is not allowed to award points or sign-off on tasks. In this case, steps S13630 and S13632 can be replaced with a new step that allows the user to set the task completed flag. In various exemplary embodiments, this step would also remove any outstanding prompts or other reminders for the task, or the current instance of the task if it is a recurring task, as the task has been marked as completed. Thus, the system would not need to provide any further prompts or reminders for the user to perform the task. In this exemplary embodiment, the new step inserted in place of steps S13630 and S13632 would also jump to step S13634.

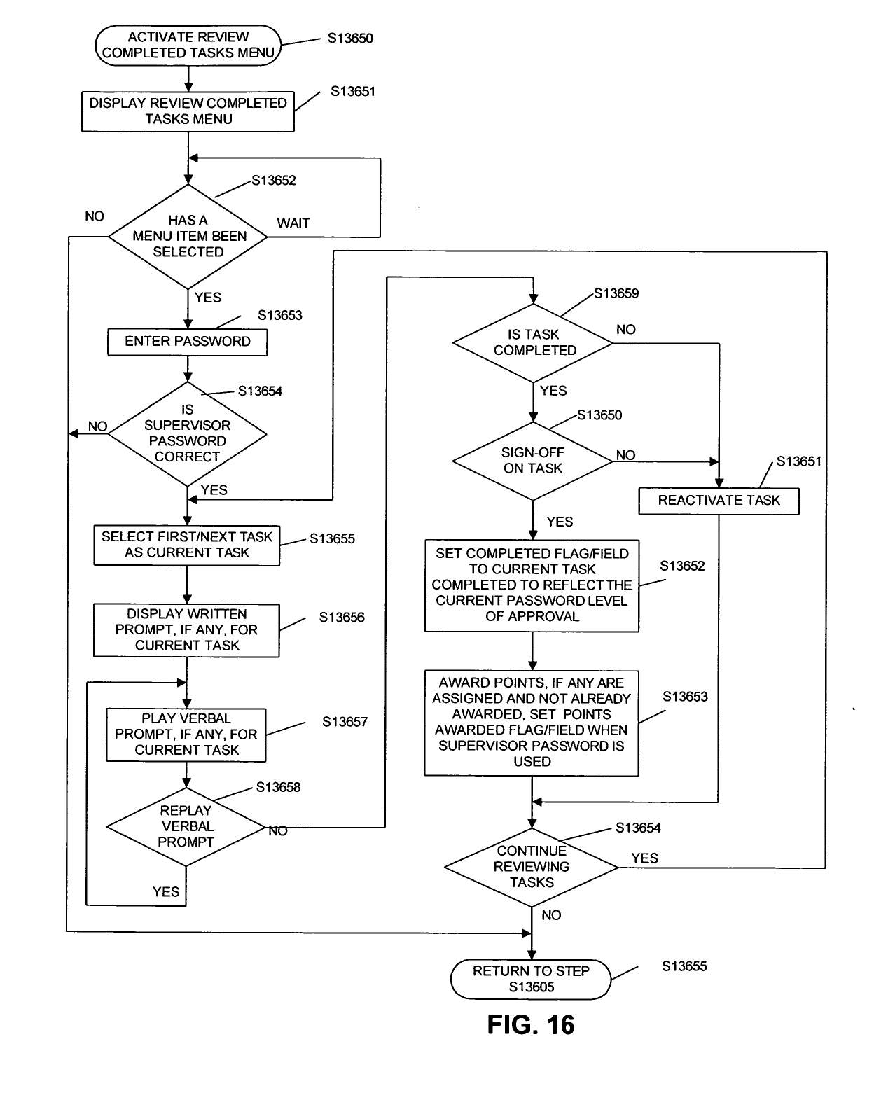

FIG. 16 outlines one exemplary embodiment of the method for activating the review completed tasks menu and/or function according to this invention. As shown in FIG. 16, in various exemplary embodiments, operation of the method begins in step S13650, and continues to step S13651, where the review completed tasks menu items are displayed. Then, in step S13652, a determination is made whether a menu item has been selected within a predetermined time period. If not, operation jumps from step S13652 to step S13665. Otherwise, operation continues to loop around step S13652 until either one of the review completed tasks menu items is selected within the predetermined time period or the predetermined time period expires. Once a review completed task menu item is selected within the predetermined time period, operation continues to step S13653, where the user is prompted to enter the system or sign-off password. Next, in step S13654, a determination is made whether the password is correct. If so, operation continues to step S13655. Otherwise, operation jumps to step S13665.

In step S13655, a first or next completed task is selected as a current task. It should be appreciated that these completed tasks can be reviewed in any desired order, and graphical user interface widgets can be provided to the user as part of step S13655 to allow that desired order to be used when selecting the completed tasks. It should be appreciated the desired order can include earliest to latest, latest to earliest, highest point total to lowest point total, tasks before reminders, reminders before tasks, signed off before completed before incomplete or visa versa or any other desired order.

Next, in step S13656, the written prompt, if any, is displayed for the current task. Then, in step S13657, the verbal prompt, if any, for the current task is played. Next, in step S13658, a determination is made whether the user wishes to have the verbal prompt, if any, replayed. If so, operation returns to step S13657. Otherwise, operation continues to step S13659. Of course, if there are not any verbal prompts recorded for the current task, this step can be skipped.

In step S13659, a determination is made whether the current task is completed. It should be appreciated that the particular actions taken in this step will differ depending on whether the entered password was the system password or the sign-off password. In particular, the exemplary embodiment shown in FIG. 16 illustrates the method used when the sign-off password has been entered. When the sign-off password has been entered, in step S13659, a determination is made whether the user has set the task completed flag or field, thus indicating that the user believes that this task has been completed. If the task has not been completed, operation jumps to step S13661. Otherwise, operation continues to step S13660.

In step S13660, because the sign-off password has been entered, a determination is made whether the supervisor has signed off on the task. In various exemplary embodiments, this comprises displaying a message to the supervisor requesting the user indicate whether or not the supervisor signs off on the task. If the task is not signed off on, operation jumps from step S13660 to step S13661. Otherwise, because the task has been completed and signed-off on, operation continues to step S13662. In step S13661, either because the task was not marked as completed by the user or because the supervisor did not sign-off on the task as actually having been completed, the task is reactivated by clearing any set completed flags or the like. Reactivating the task can also include one or more of adding the reactivated task to the task list, scheduling the prompts programmed into the system for this task or the like. Operation then jumps to step S13664.

In contrast, in steps S13662, the completed flag or field is set to indicate that the current task has been completed based on the level of approval associated with the password entered in step S13653. Next in step S13663, the defined incentive, such as points, a monetary award, an award of privileges or the like, if any points are assigned and not already awarded to this task, are awarded and the points awarded flag or field for this task is set. Operation then continues to step S13664, where a determination is made whether the user or supervisor wishes to continue reviewing tasks. If so, operation jumps back to step S13655. Otherwise, operation continues to step S13665, which returns control to step S13605.

It should be appreciated that, in various exemplary embodiments where the system password rather than the sign-off password has been entered, steps S13660 and S13662 can be omitted, as the user, rather than the supervisor, is not allowed to award points or sign-off on tasks. In this case, steps S13660 and S13662 can be replaced with a new step allows the user to set the task completed flag. In various exemplary embodiments, this step would also remove any outstanding prompts or other reminders for the task, or the current instance of the task if it is a recurring task, as the task has been marked as completed. Thus, the system would not need to provide any further prompts or reminders for the user to perform the task. In this exemplary embodiment, the new step inserted in place of steps S13660 and S13662 would also jump to step S13664.

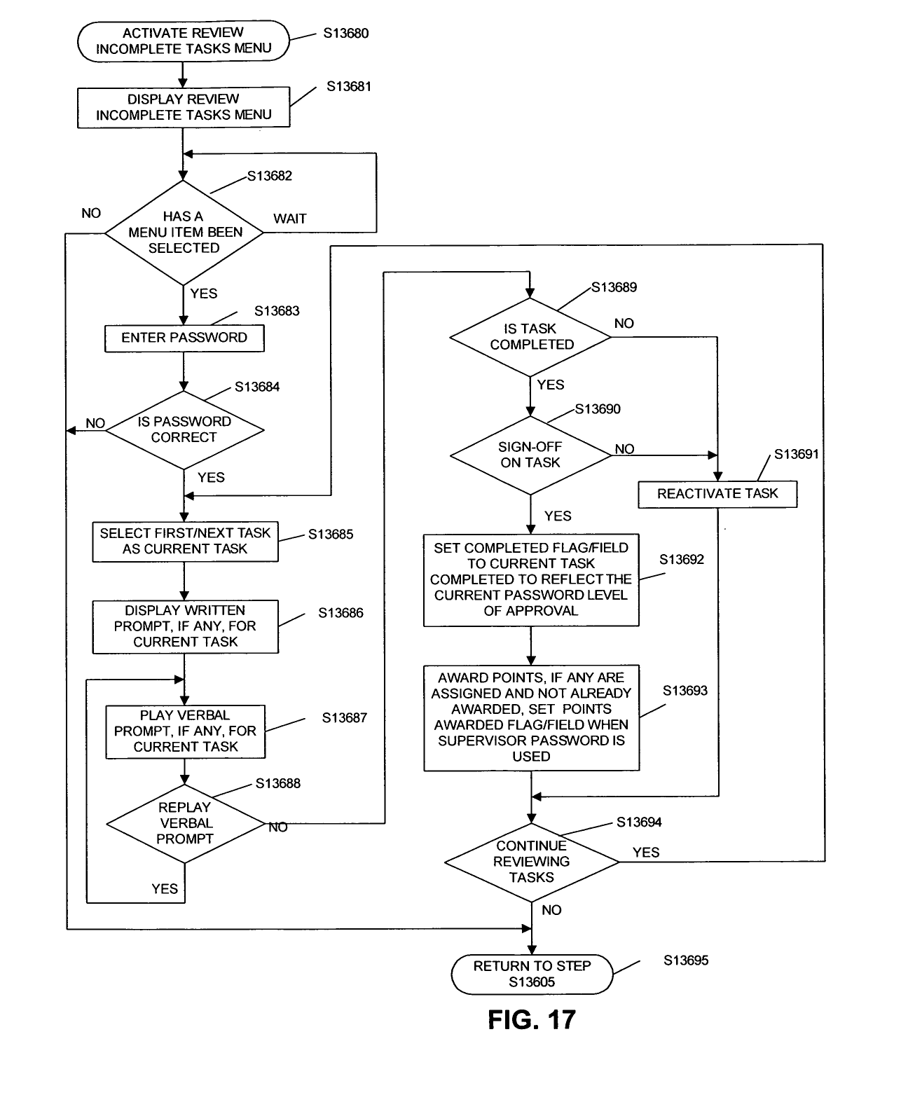

FIG. 17 outlines one exemplary embodiment of the method for activating the review incomplete tasks menu and/or function according to this invention. As shown in FIG. 17, in various exemplary embodiments, operation of the method begins in step S13680, and continues to step S13681, where the review incomplete tasks menu items are displayed. Then, in step S13682, a determination is made whether a menu item has been selected within a predetermined time period. If not, operation jumps from step S13682 to step S13695. Otherwise, operation continues to loop around step S13682 until either one of the review incomplete tasks menu items is selected within the predetermined time period or the predetermined time period expires. Once a review incomplete task menu item is selected within the predetermined time period, operation continues to step S13683, where the user is prompted to enter the system or sign-off password. Next, in step S13684, a determination is made whether the password is correct. If so, operation continues to step S13685. Otherwise, operation jumps to step S13695.

In step S13685, a first or next incomplete task is selected as a current task. It should be appreciated that these incomplete tasks can be reviewed in any desired order, and graphical user interface widgets can be provided to the user as part of step S13685 to allow that desired order to be used when selecting the incomplete tasks. It should be appreciated that the desired order can include earliest to latest, latest to earliest, highest point total to lowest point total, tasks before reminders, reminders before tasks, signed off before completed before incomplete or visa versa or any other desired order.

Next, in step S13686, the written prompt, if any, is displayed for the current task. Then, in step S13687, the verbal prompt, if any, for the current task is played. Next, in step S13688, a determination is made whether the user wishes to have the verbal prompt, if any, replayed. If so, operation returns to step S13687. Otherwise, operation continues to step S13689. Of course, if there are not any verbal prompts recorded for the current task, this step can be skipped.

In step S13689, a determination is made whether the current task is completed. It should be appreciated that the particular actions taken in this step will differ depending on whether the entered password was the system password or the sign-off password. In particular, the exemplary embodiment shown in FIG. 17 illustrates the method used when the sign-off password has been entered. When the sign-off password has been entered, in step S13689, a determination is made whether the user has set the task completed flag or field, thus indicating that the user believes that this task has been completed. If the task has not been completed, operation jumps to step S13691. Otherwise, operation continues to step S13690.

In step S13690, because the sign-off password has been included, a determination is made whether the supervisor has signed off on the task. In various exemplary embodiments, this comprises displaying a message to the supervisor requesting the user indicate whether or not the supervisor signs off on the task. If the task is not signed off on, operation jumps from step S13690 to step S13691. Otherwise, because the task has been completed and signed-off on, operation continues to step S13692. In step S13691, either because the task was not marked as completed by the user or because the supervisor did not sign-off on the task as actually having been completed, the task is reactivated by clearing any set completed flags or the like. Reactivating the task can also include one or more of adding the reactivating the task to the task list, scheduling the prompts programmed into the system for this task or the like. Operation then jumps to step S13694.

In contrast, in steps S13692, the completed flag or field is set to indicate that the current task has been completed based on the level of approval associated with the password entered in step S13683. Next in step S13693, the defined incentive, such as points, a monetary award, an award of privileges or the like, if any points are assigned and not already awarded to this task, are awarded and the points awarded flag or field for this task is set. Operation then continues to step S13694, where a determination is made whether the user or supervisor wishes to continue reviewing tasks. If so, operation jumps back to step S136856. Otherwise, operation continues to step S13695, which returns control to step S13605.

It should be appreciated that, in various exemplary embodiments where the system password rather than the sign-off password has been entered, steps S13690 and S13692 can be omitted, as the user, rather than the supervisor, is not allowed to award points or sign-off on tasks. In this case, steps S13690 and S13692 can be replaced with a new step allows the user to set the task completed flag. In various exemplary embodiments, this step would also remove any outstanding prompts or other reminders for the task, or the current instance of the task if it is a recurring task, as the task has been marked as completed. Thus, the system would not need to provide any further prompts or reminders for the user to perform the task. In this exemplary embodiment, the new step inserted in place of steps S13690 and S13692 would also jump to step S13694.

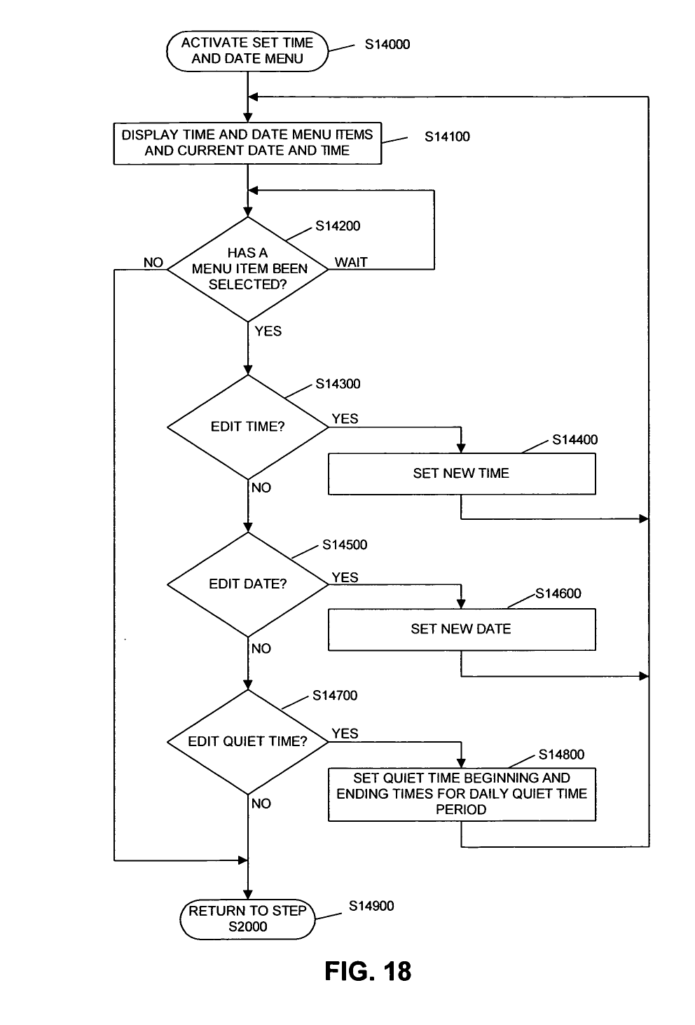

FIG. 18 is a flowchart outlining one exemplary embodiment of a method for activating the set time and date menu and/or function according to this invention. As shown in FIG. 18, in various exemplary embodiments, operation of the method begins in step S14000 and continues to step S14100, where the time and date menu items and the current entered date and time are displayed. Next, in step S14200, a determination is made whether a menu item has been selected within a predetermined time period. If not, operation jumps directly to step S14900. Otherwise, operation continues to loop around step S14200 until either one of the time and date menu items is selected within the predetermined time period or the predetermined time period expires. Once a time and date menu item is selected, operation continues to step S14300, where a determination is made whether the edit time menu item and/or function has been selected. If so, operation continues to step S14400. Otherwise, operation jumps to step S14500. In step S14400, the user is presented with one or more graphical user interface widgets that allow the user to set and save a new time. Operation then returns to step S14100.

In step S14500, a determination is made whether the edit date menu item and/or function is selected. If so, operation continues to step S14600. Otherwise, jumps to step S14700. In step S14600, one or more graphical user interface widgets are displayed to the user or supervisor to allow the user or supervisor to set and save a new date. Operation then again returns to step S14100.

In step S14700, a determination is made whether the edit quiet time menu and/or function has been selected. If so, operation continues to step S14800. Otherwise, operation jumps directly to step S14900. In step S14800, the user is presented with one or more graphical user interface widgets that allow the user to set a quiet time beginning and ending time for each desired quiet time period. Operation then continues to step S14900, where operation of the method returns to step S2000.

It should be appreciated that, in step S14800, the user can set multiple quiet times. Alternatively, the one or more graphical user interface widgets displayed in step S14800 can be accessed multiple times to set up various quiet time periods. It should be appreciated that a quiet time period is one in which the system will not do anything to notify the user that there are unacknowledged prompts, such as unacknowledged reminders or incomplete tasks that need attention. Such quiet time periods can include, for example, while the user is sleeping, is away at school or the like, or other periods which the user or supervisor does not want reminders generated, such as periods devoted to religious observances or the like or any other basis for wanting to suppress the system from reminding the user about incomplete tasks and unacknowledged reminders.

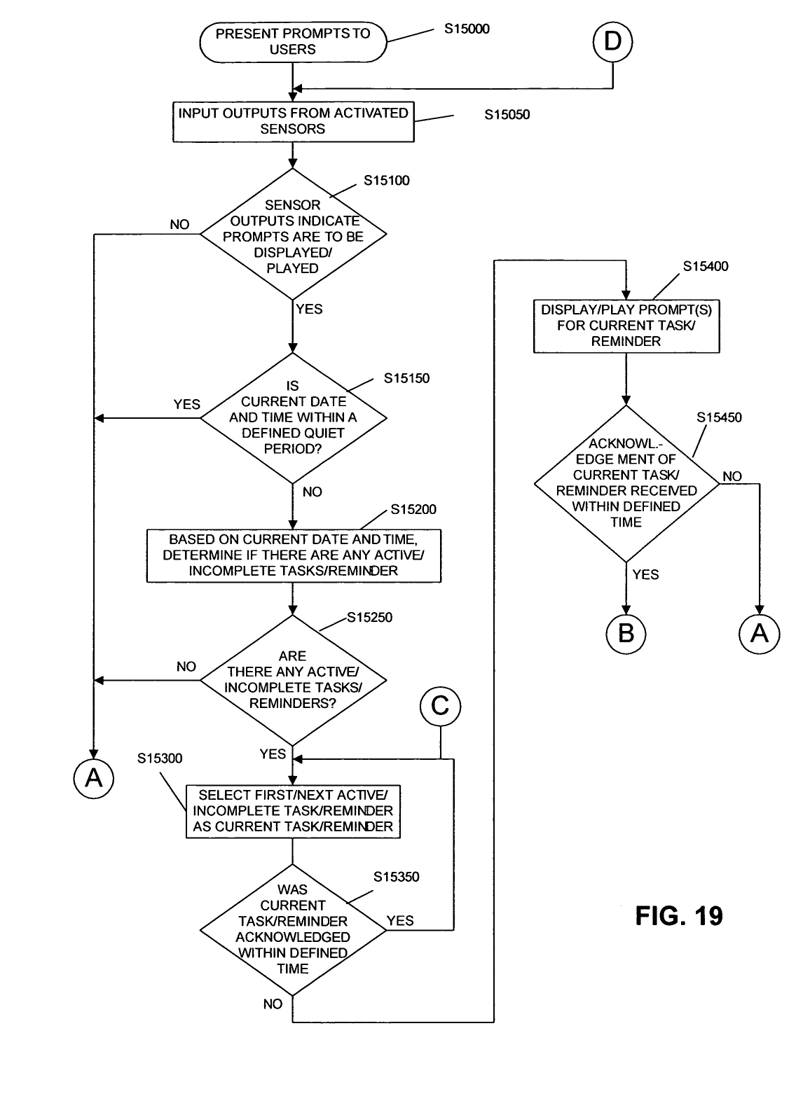

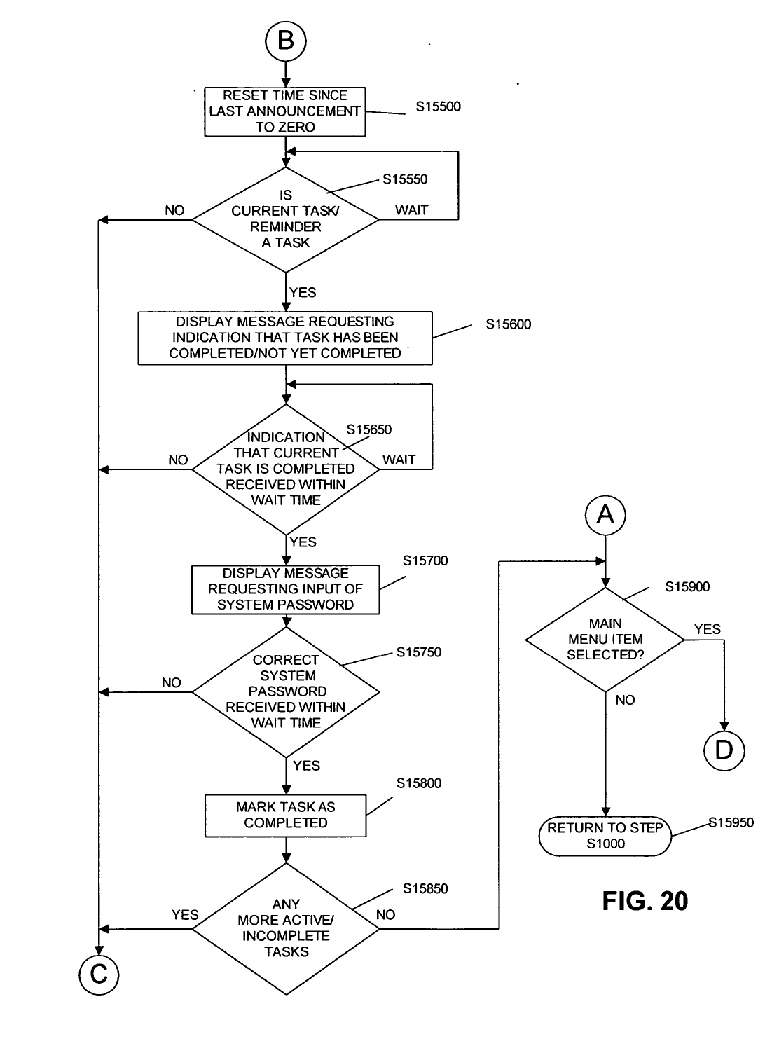

FIGS. 19 and 20 are a flowchart outlinign one exemplary embodiment of a method for presenting prompts regarding unacknowledged reminders and/or incomplete tasks according to this invention. As shown in FIGS. 19 and 20, operation of the method begins in step S15000 and continues to step S15050, where outputs from the enabled sensors are input. Then, in step S15100, a determination is made whether the sensor outputs indicate that prompts are to be displayed and/or played to the user or supervisor. It should be appreciated that the output signals from the various sensors will indicate that the prompts are to be displayed and/or played when the sensors detect the light level in the location around the base unit has increased; motion in the vicinity of the device is detected; or sounds which appear to be made in the vicinity of the device are detected. If none of the sensor outputs are consistent with the user being in the vicinity of the device, operation jumps to step S15900. Otherwise, if one or more of the sensors are consistent with the user, or some other person or entity, being in the vicinity of the device, operation continues to step S15150.

In step S15150, a determination is made whether the current time and date are within a quiet period where the operation of the device is suspended. If so, operation again jumps to step S15900. Otherwise, operation continues to step S15200, where the list of tasks is reviewed to identify any active and incomplete tasks or active and unacknowledged reminders or the like. Then, in step S15250, a determination is made whether there are any identified active and incomplete tasks or active and unacknowledged reminders. If not, operation again jumps to step S15900. Otherwise, operation continues to step S15300.

In step S15300, a first or next active and incomplete task or active and unacknowledged reminder is selected as the current task or reminder. Then, in step

a determination is made whether the current task or reminder has been acknowledged by the user in response to the current announcement within the defined time between announcements. That is, as outlined above, each task or reminder will be announced one or more times before its due date. For example, a daily chore may be announced hourly, while a weekly chore may be announced daily. Thus, it may be possible for the user to have acknowledged an announcement during a previous announcement period. However, the incomplete task or unacknowledged reminder may not have been acknowledged during the current announcement period. Because each of the different tasks and reminders will typically have different frequencies and different announcement parameters, it is necessary to determine whether the current task or reminder should be announced, because it has not been acknowledged for the current acknowledgment period, or does not need to be announced, because it has already been acknowledged during the current announcement period. Accordingly, if the current task or reminder has been acknowledged within the current announcement period for the task, operation jumps from step S15350 back to step S15300. Otherwise, operation continues to step S15400.

In step S15400, the written prompt, if any, and the verbal prompt, if any, are played to announce the current task or reminder to the user, so that the user knows either that the current task has not been completed and needs to be completed and the completion recorded, or that the user needs to acknowledge the current task or reminder. Next, in step S15450, a determination is made whether the user has acknowledged the current task or reminder within a predetermined time period. If not, operation jumps to step S15900. Otherwise, operation loops around step S15450 until the user acknowledges the announcement of the current task or reminder within the predetermined time period or the predetermined time period expires. Once the announcement of the current task or reminder is acknowledged, operation continues to step S15500.

It should be appreciated that, in various exemplary embodiments, allowing the acknowledgment of the current task or reminder to time out in step S15450 allows the system to be more tolerant of the sensor inputs. For example, if the system is being used to aid a child in remembering and completing the child's tasks and reminders, and the child's household has one or more pets, it is possible that the motion and/or sound sensors will react to one or more of the one or more pets coming into the room and triggering the motion sensor and/or the sound sensor. For example, a dog that barks loudly and/or wags its tail or walks in close proximity of the device could cause one or both of the motion sensors and the sound sensors to generate output signals that are consistent with the user coming into the vicinity of the device. Likewise, if the lights are turned on, for example by another member of the household, even though the announcement is made in step S15450, there is actually no one present to acknowledge the announcement. Thus, by allowing the announcement acknowledgment to time out, the system can reset itself by jumping to step S15900.

In step S15500, because the user has acknowledged the current task or reminder announcement within the predetermined time period, the system records that the current announcement for the current task or reminder has been acknowledged. In various exemplary embodiments, this can be done by setting an acknowledgment flag associated with the current predetermined time period for the current task or reminder. In various other exemplary embodiments, a counter associated with the current task or reminder can be reset to zero. Then, when the counter exceeds the defined time period between announcements, the system will know that the task or reminder associated with that counter again needs to be announced to the user.

Next, in step S15550, a determination is made whether the current task or reminder is a task, rather than a reminder. If not, i.e., the current task or reminder is a reminder, operation jumps back to step S15300, as nothing more needs to be done upon the user acknowledging that he has received that reminder. In contrast, if the current task or reminder is a task, operation continues to step S15600.

In step S15600, a message is displayed to the user requesting the user to indicate whether the current task has been completed or is not yet completed. Then, in step S15650, a determination is made whether the user has put in an indication that the current task is in fact completed within a predetermined time period. If not, operation jumps back to step S15300. Otherwise, operation loops around step S15650 until either the indication is received within the predetermined time period, or the predetermined time period expires. When the indication that the current task is completed is received within the predetermined time period, operation continues from step S15650 to step S15700.

In step S15700, a message is displayed to the user requesting the user to input the system password. Then, in step S15750, a determination is made whether the correct system password has been input within the predetermined time period. If not, operation jumps back to step S15300. Otherwise, operation of the method loops around step S15750 until either the correct system password is received within the predetermined time period or the predetermined time period expires. Once the correct system password is received within the predetermined time period, operation continues from step S15750 to step S15800.

In step S15800, the current task is marked as completed. Then, in step S15850, a determination is made whether there are any more active and incomplete tasks or unacknowledged reminders that need to be announced to the user. If so, operation jumps back to step S15300. Otherwise, operation continues to step S15900.

In step S15900, one or more graphical user interface widgets are displayed to the user requesting the user make an indication of whether the user wishes to look to the main menu or return to step S15050. If no response is received within a predetermined time period, operation loops around step S15900 until either the predetermined time period expires or the user indicates the user wishes to return to step S15050. When an indication that the user wishes to return to step S15050, operation continues from step S15900 to step S15050. In contrast, in step S15950, operation of the method returns to step S1000.

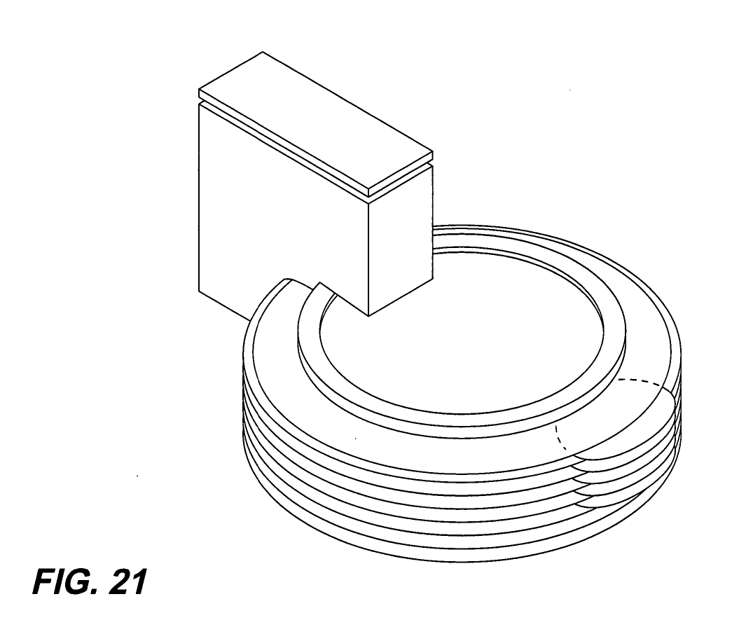

FIG. 21 illustrates one exemplary embodiment of a device 300 according to this invention. As shown in FIG. 21, the device 300 includes a touch screen 200.

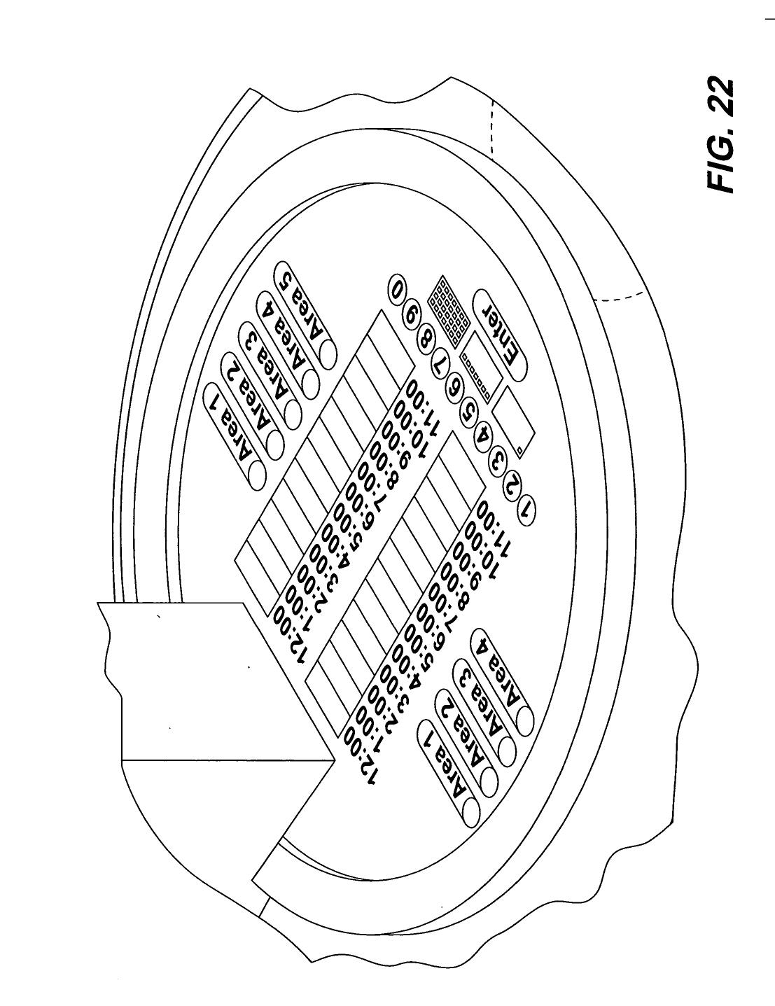

FIG. 22 shows one exemplary embodiment of the display device 200 and the various menu items and other graphical elements displayable on the display device 200 shown in FIG. 1. Because the display device 200 shown in FIGS. 21 and 22 is a touch screen, the display device 200 can be used to select various menu items, input data, review tasks and/or prompts, and/or the like.

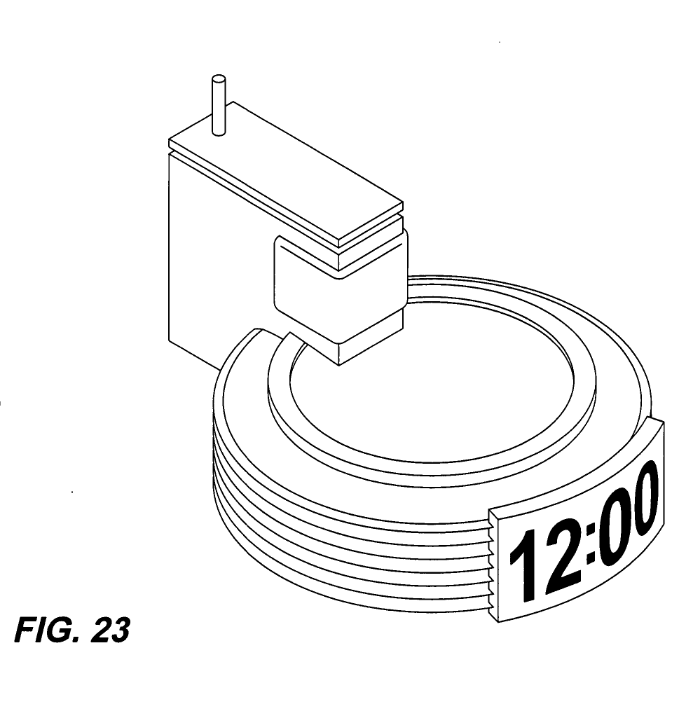

FIG. 23 shows a second exemplary embodiment of the device 300. As shown in FIG. 23, the device 300 also incorporates an alarm clock display that indicates the date and/or time and allows the device 200 to be used as an alarm clock as well as to manage tasks and reminders.

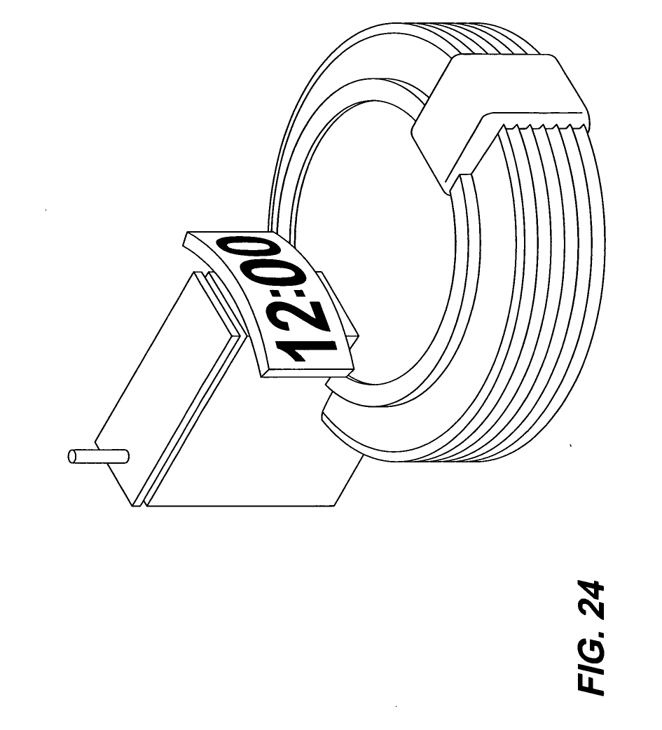

FIG. 24 shows a third exemplary embodiment of the device 200, where the alarm clock display portion is located at a different position.

As outlined above, the system and methods for managing tasks and reminders act as a replacement for the constant reminders that parents or other supervisors provide to children or other subordinates requiring supervision to get the children or other subordinates to accomplish tasks and keep in mind various dates, events and other items they need reminding about. Based on sensing motion or changes in light and/or sound levels, the systems and methods for managing tasks and reminders according to this invention provides verbal and/or written reminders or prompts when the user is determined to be in the vicinity of the device. The reminders or prompts for a task or event will start at a designated time prior to that task or event being due for any specific task or event. The reminders or prompts will continue at fixed intervals until turned off by the user. For tasks, each task can individually be programmed to require the parent or supervisor to confirm that the task was completed. Upon completion of various tasks, incentives, such as points, privileges and the like can be awarded to the user and completion of various tasks over various time frames can be reviewed.

While this invention has been described in conjunction with the exemplary embodiments outlined above, various alternatives, modifications, variations, improvements and/or substantial equivalents, whether known or that are or may be presently foreseen, may become apparent to those having at least ordinary skill in the art. Accordingly, the exemplary embodiments of the invention, as set forth above, are intended to be illustrative, not limiting. Various changes may be made without departing from the spirit or scope of the invention. Therefore, the invention is intended to embrace all known or later developed alternatives, modifications, variations, improvements and/or substantial equivalents.

1-20. (canceled)

21. A task management device, comprising:
a display device usable to display at least one of menu information and task information to a user;
at least one user input device usable to input at least one of menu selection information and task information;
memory usable to store at least one of menu information and task information;
at least one time-keeping structure usable to measure and provide calendar and time of day information; and
at least one sensor usable to detect a change in an associated environmental variable of an environment in which the task management device is located;
wherein, upon at least one of the at least one sensor detecting a change in the associated environmental variable, the time management device identifies any active tasks based on the time of day and calendar information provided by at least one of the at least one time keeping structure and task information stored in the memory and, if at least one active task is identified, outputs an indication that there is at least one active task requiring attention.

22. The task management device of claim 21, wherein the task information includes at least task definition information.

23. The task management device of claim 22, wherein the task definition information includes at least one of a task identifier, task completion time information, task prompting information, task incentive information and task repetition information.

24. The task management device of claim 23, wherein the task completion time information includes at least one of a task completion time and a task completion window.

25. The task management device of claim 23, wherein the task repetition information includes at least one of start time information, stop time information and repetition frequency information.

26. The task management device of claim 21, wherein the task information includes at least task completion information.

27. The task management device of claim 26, wherein the task completion information includes at least one of task status information and awarded incentive information.

28. The task management device of claim 21, wherein the menu information includes at least one of personal information menu information, password maintenance menu information, program prompts menu information, activate sensors menu information, review task menu information and set time and date menu information.

29. The task management device of claim 28, wherein the program prompts menu information includes at least one of a prompt time setting widget, a prompt date setting widget, recurring prompt programming information, a lead time setting widget, a lead days setting widget, a prompt interval/frequency setting widget and prompt data menu information.

30. The task management device of claim 29, wherein the recurring prompt programming information includes at least one of an end date setting widget, an occurrence number setting widget, and at least one interval setting widget.

31. The task management device of claim 29, wherein the prompt data menu information includes at least one of a verbal prompt data recording widget, a written prompt data recording widget, at least one task type setting widget and a task incentive setting widget.

32. The task management device of claim 28, wherein the review task menu information includes at least one of an incentive reviewing widget, task reviewing menu information and task status revising menu information.

33. The task management device of claim 1, wherein the at least one sensor comprises at least one of a motion detector, where the change in the associated environmental variable includes motion in the environment around the task management device, a sound detector, where the change in the associated environmental variable includes a change in sound level in the environment around the task management device, and a light detector, where the change in the associated environmental variable includes a change in a light level in the environment around the task management device.

34. A method for prompting a first person using a task management device regarding tasks assigned to the first person by at least one second person or by the first person, comprising:
detecting a change in at least one environmental variable of an environment in which the task management device is located;
in response to detecting the change in at least one of the at least one environmental variable, identifying any assigned task that is active based on a current date and time and task information regarding the assigned tasks available to the task management device; and
for at least one identified active task, outputting at least one of a verbal prompt and a written prompt, such that, if the first person is in the environment around the task management device, the first person is able to be reminded of that task by at least one of the at least one of the verbal prompt and the written prompt.

35. The method of claim 34, further comprising inputting, for at least one identified active task, an indication acknowledging the at least one output prompt for that identified active task.

36. The method of claim 35, wherein:
if the indication indicates that the associated task has been completed, changing a status of that task from active to completed and halting the at least one output prompt until that task again becomes active; and
if the indication indicates that the associated task has not been completed, halting the at least one output prompt for a predetermined interval;

37. The method of claim 36, further comprising:
reviewing, by at least one of the at least one second person, tasks whose status has been changed to completed by the first person;
inputting, for at least one completed task, an indication indicating that second person approves that the task has been completed; and
awarding, for each such approved competed task, any incentive associated with that approved completed task to the first person.

38. The method of claim 36, further comprising:
reviewing, by at least one of the at least one second person, tasks whose status has been changed to completed by the first person;
inputting, for at least one completed task, an indication indicating that second person does not approve that the task has been completed; and
re-activating, for each such non-approved task, that non-approved task for re-presenting to and completion by the first person.

39. A method for creating prompts to prompt a first person, using a task management device, to complete a desired task assigned to the first person by at least one second person or by the first person, comprising:
inputting a task identifier for the desired task;
inputting task type information for the desired task;
inputting task completion date information for the desired task; and
inputting prompt information for the desired task.

40. The method of claim 39, further comprising inputting task completion incentive information for the desired task.

41. The method of claim 39, wherein inputting prompt information for the desired task comprises at least one of:
inputting a written prompt to be displayed to the first person for the desired task;
inputting a verbal prompt to be played to the first person for the desired task;
inputting a prompt start date defining when a date when the prompt should first be provided to the first person for the desired task;
inputting a prompt start time defining when a time of day when the prompt should initially be provided to the first person for the desired task; and
inputting a prompt interval defining a time between providing the prompt to the first person a first time and providing the prompt to the first person a second time.
